(19) United States
(12) Patent Application Publication
(10) Pub. No.: US 2024/0095238 A1
(43) Pub. Date: Mar. 21, 2024

(54) SYSTEMS AND METHODS FOR MANUFACTURED DATA GENERATION AND MANAGEMENT VIA AN INTERACTIVE MANUFACTURED DATASET LIBRARY

(71) Applicant: Wells Fargo Bank, N.A., San Francisco, CA (US)

(72) Inventors: Dale C. Miller, Winston-Salem, NC (US); Carrie Anne Hanson, Charlotte, NC (US)

(21) Appl. No.: 18/317,006

(22) Filed: May 12, 2023

Related U.S. Application Data
(63) Continuation of application No. 18/176,336, filed on Feb. 28, 2023, now abandoned.
Application No. 18/176,336 is a continuation-in-part of application No. 17/932,637, filed on Sep. 15, 2022.

(51) Int. Cl. G06F 16/242; G06F 16/2455; G06F 16/248; G06F 21/62

(52) U.S. Cl. CPC G06F 16/243; G06F 16/2455; G06F 16/248; G06F 21/6227

(57) ABSTRACT

Systems, apparatuses, methods, and computer program products are disclosed for manufactured dataset generation and management. An example method includes receiving, by communications hardware, a user input set indicating data manufacture requirements. The example method also includes generating, by query generation circuitry, a manufactured dataset library query based on the data manufacture requirements. The example method also includes receiving, by the communications hardware and based on an execution of the manufactured dataset library query, a set of results comprising one or more manufactured datasets of a manufactured dataset library, the one or more manufactured datasets having been previously generated based on one or more previously received user input sets. The example method also includes generating, by dataset generation circuitry, a manufactured dataset based on the set of results.

### CROSS-REFERENCE TO RELATED APPLICATIONS

This application is a continuation of U.S. patent application Ser. No. 18/176,336, filed Feb. 28, 2023, which is a continuation-in-part of U.S. patent application Ser. No. 17/932,637, filed Sep. 15, 2022, the entire contents of each of which are incorporated herein by reference.

### BACKGROUND

Manufactured data (e.g., synthetic data, tokenized data, obfuscated data, etc.) is valuable as a source of data for training and testing models (e.g., machine learning models and the like). However, existing processes for generating and/or interacting with manufactured data are often complex and require extensive domain knowledge, thus excluding certain end users.

### BRIEF SUMMARY

Manufactured data is an effective tool in the field of data science. One example of manufactured data is synthetic data. Unlike authentic data (e.g., data generated based on real-world events), synthetic data is not obtained by direct measurement and is instead artificially manufactured. Synthetic data may be generated algorithmically and can be used as a stand-in for datasets of production and/or operational data. Synthetic data helps reduce constraints when faced with issues concerning sensitive or regulated data, and can also be used to tailor datasets to certain conditions that cannot be obtained from authentic data. As another advantage, synthetic data can be used to generate large training datasets without requiring manual labeling of data. Synthetic data that mimics real-world observations can also be used to train or test models (e.g., machine learning (ML) models) when authentic data is difficult and/or expensive to acquire.

Another example of manufactured data is obfuscated data (sometimes referred to as masked data, tokenized data, or anonymized data). Data obfuscation is the process of altering sensitive data in such a way that it is of little or no value to unauthorized individuals who may gain access to it yet still remains useable by software or personnel such as data scientists. In other words, by hiding the data's actual value, data obfuscation renders data useless to attackers while retaining its utility for data teams, particularly in non-production environments. For individuals (e.g., data scientists, developers, and/or the like) using potentially sensitive customer or company data to build and test applications in non-production environments, being able to access quality data is critical. However, non-production environments often do not have sufficient security perimeters or access controls in place, leaving data vulnerable to attack. In this regard, data obfuscation allows developers and testers to access realistic data, but since the data no longer contains personally identifiable information (PII), they can do so without the concern of the data being exploited or incurring privacy compliance issues.

However, as noted herein, effective creation of manufactured data has traditionally required end users to have extensive domain knowledge regarding how manufactured data is generated and various requirements for the manufactured data. In this regard, many individuals who may wish to generate and use manufactured data are not equipped with the sufficient training or experience to generate suitable manufactured data. In various situations, this can result in multiple technical problems. For example, with respect to synthetic data, synthetic datasets may be generated that are unknowingly misrepresentative (or non-representative) of the authentic datasets that they are intended to replicate (e.g., stand-in for). If used to train or test a model, this misrepresentative synthetic data may cause various undesirable results, e.g., inaccurate model output, uninterpretable model output, model biases, etc. As another example, an individual that does not have access to quality synthetic data may instead rely solely on an inadequate authentic dataset (e.g., inadequate in quantity and/or quality). If inadequate training data is used to train a model (e.g., an ML model), many of the undesirable results discussed above may also occur, such as inaccurate model output, uninterpretable model output, model biases, and/or the like.

Similarly, with respect to obfuscated data, an inexperienced end user may attempt to use various data masking techniques to scramble or otherwise obfuscate data with mixed results. For instance, the end user may overlook some aspects of their dataset during their analysis and fail to obfuscate certain data, thus potentially leaving PII vulnerable to exposure and exploitation.

A technical need therefore exists for new tools that can facilitate the generation and management of manufactured datasets by a wider population while mitigating various undesirable results. Systems, apparatuses, methods, and computer program products are disclosed herein for manufactured dataset generation and management via an interactive manufactured dataset library. Example embodiments leverage a user-friendly interactive interface that allows end users to define various requirements for a manufactured dataset (e.g., a synthetic dataset or obfuscated dataset). Through the interactive interface, a “low-code” solution to existing complex manufactured data generation processes is provided that makes efficient and suitable manufactured data generation available to, and accessible by, a wider population. Advantageously, the interactive user interface also provides insights into backend manufactured data generation processes traditionally unavailable for analysis by end users. Example embodiments also include an interactive manufactured dataset library configured to store and protect manufactured datasets generated via the systems disclosed herein. As further described herein, manufactured datasets stored in the manufactured dataset library are able to be browsed and securely accessed (e.g., via a visual user interface) by various end users who may wish to utilize the manufactured datasets for model training, model testing, and/or other applications.

In addition to the technical benefits described above, and elsewhere herein, the described systems, apparatuses, methods, and computer program products may result in improved machine learning model performance by virtue of error reduction in manufactured datasets used as machine learning model training data or testing data. That is, various examples described herein provide a technical advancement in the areas of machine learning model training and/or operation.

In one example embodiment, a method is provided for manufactured data generation and management. The method includes receiving, by communications hardware, a user input set indicating data manufacture requirements. The method also includes generating, by query generation circuitry, a manufactured dataset library query based on the data manufacture requirements. The method also includes receiving, by the communications hardware and based on an execution of the manufactured dataset library query, a set of results comprising one or more manufactured datasets of a manufactured dataset library, the one or more manufactured datasets having been previously generated based on one or more previously received user input sets. The method also includes generation, by dataset generation circuitry, a manufactured dataset based on the set of results.

In another example embodiment, an apparatus is provided for manufactured data generation and management. The apparatus includes communications hardware configured to receive a user input set indicating data manufacture requirements. The apparatus also includes query generation circuitry configured to generate a manufactured dataset library query based on the data manufacture requirements. The communications hardware is also configured to receive, based on an execution of the manufactured dataset library query, a set of results comprising one or more manufactured datasets of a manufactured dataset library, the one or more manufactured datasets having been previously generated based on one or more previously received user input sets. The apparatus also includes dataset generation circuitry configured to generate a manufactured dataset based on the set of results.

In another example embodiments, a computer program product is provided for manufactured data generation and management. The computer program product includes at least one non-transitory computer-readable storage medium storing software instructions that, when executed, cause an apparatus to receive a user input set indicating data manufacture requirements. The software instructions, when executed, further cause the apparatus to generate a manufactured dataset library query based on the data manufacture requirements. The software instructions, when executed, further cause the apparatus to receive, based on an execution of the manufactured dataset library query, a set of results comprising one or more manufactured datasets of a manufactured dataset library, the one or more manufactured datasets having been previously generated based on one or more previously received user input sets. The software instructions, when executed, further cause the apparatus to generate a manufactured dataset based on the set of results.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for manufactured data generation and management.

FIG. 2 illustrates a schematic block diagram of example circuitry embodying a device that may perform various operations in accordance with some example embodiments described herein.

FIG. 3 illustrates a schematic block diagram of example circuitry embodying a device that may perform various operations in accordance with some example embodiments described herein.

FIG. 4 illustrates an example user interface used in some example embodiments described herein.

FIG. 5 illustrates an example flowchart for manufactured data generation and management, in accordance with some example embodiments described herein.

FIG. 6 illustrates an example flowchart for executing an extended dataset query in conjunction with a dataset library query, in accordance with some example embodiments described herein.

FIG. 7 illustrates an example flowchart for identifying and retrieving existing queries and/or manufactured datasets in the event a matching threshold is satisfied, in accordance with some example embodiments described herein.

FIG. 8 illustrates an example flowchart for applying and utilizing one or more security restrictions within a manufactured dataset library, in accordance with some example embodiments described herein.

FIG. 9 illustrates an example flowchart for recommending previously generated manufactured datasets based on a project similarity threshold, in accordance with some example embodiments described herein.

FIG. 10 illustrates an example flowchart for providing a feedback loop mechanism within a manufactured dataset library, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “manufactured dataset” is used to refer to a collection of data that has been manufactured in some form. A manufactured dataset may include data that has been obfuscated (e.g., tokenized, anonymized, and/or otherwise modified to some degree). A manufactured dataset may additionally or alternatively include synthetic data (e.g., data that is artificially generated (for example, via one or more synthetic data generation algorithms) rather than produced by real-world events). A manufactured dataset may include any combination of synthetic data and obfuscated data, and in some instances may also include authentic data (e.g., data produced by real-world events that has not been obfuscated) in addition to synthetic and/or obfuscated data. A manufactured dataset may be generated based on data (e.g., raw data, labeled and/or unlabeled data, existing datasets) collected from one or more sources (e.g., a modified dataset library and/or one or more remote data sources such as repositories, servers, storage devices and/or the like). In some embodiments, a manufactured dataset may be generated based on data manufacture requirements (e.g., specific parameters needed in a desired manufactured dataset) provided by a user and using one or more existing datasets (e.g., existing modified datasets, authentic datasets, obfuscated datasets, and/or the like).

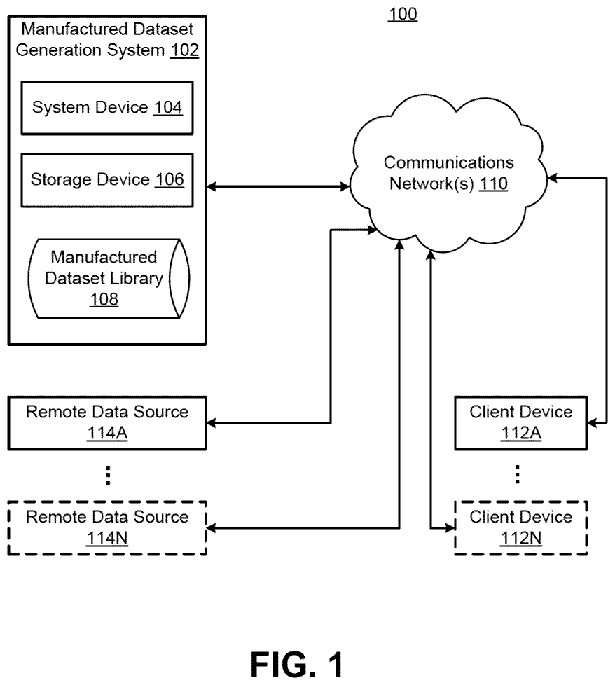

The term “manufactured dataset library” is used to refer to a digital repository configured to store a plurality of manufactured datasets. Manufactured datasets may be stored in a manufactured dataset library upon being generated by a manufactured dataset generation system (discussed below in connection with FIG. 1). Manufactured datasets that are stored in the manufactured dataset library may be indexed, categorized, or otherwise organized in some fashion according to various information (e.g., metadata) regarding the manufactured datasets. A manufactured dataset library may be interactive in that users of the manufactured dataset generation system may access and retrieve manufactured datasets for various applications. In some embodiments, users may interact with the manufactured dataset library via a digital user interface (e.g., generated by the manufactured dataset generation system) that displays a visual representation of information regarding the manufactured datasets stored in the manufactured dataset library.

The term “manufactured dataset generation user interface” is used to refer to a visual user interface (UI) with which users can easily interact to define necessary parameters of a desired manufactured dataset. In various embodiments, the parameters provided by a user via the manufactured dataset generation UI are subsequently leveraged by the manufactured dataset generation system to identify existing data and/or datasets and automatically generate a suitable manufactured dataset for the user. The manufactured dataset generation UI enables users to easily modify various requirements and other information for a desired manufactured dataset using intuitive UI design elements. The information that can be modifiable may include metadata about the manufactured data to be created (e.g., types of data, location of data, amount of data), privacy levels and/or requirements (e.g., a level of obfuscation from source data), allowable degrees of bias (e.g., enabling intentionally biased data or a more normal distribution), allowable degrees of authentic data to be included in the manufactured dataset, or any other suitable parameter. In some embodiments, the manufactured dataset generation UI may enable selection of algorithms to use for manufactured dataset generation (e.g., Monte-Carlo methods, neural networks, other ML-based methods, etc.). In some embodiments, the manufactured dataset generation UI may also include an input component capable of capturing text and/or audio data submitted by a user. For example, instead of (or in addition to) utilizing various UI design elements of the manufactured dataset generation UI to define parameters for a desired manufactured dataset, a user may dictate their parameters vocally and submit a user input set (further discussed below) comprising audio data. The manufactured dataset generation system may then process the audio data (e.g., using Natural Language Processing (NLP) techniques and/or the like) to identify the parameters and subsequently generate a manufactured dataset. The ability for a user to vocally dictate various requirements of a desired manufactured dataset via the modified dataset generation UI may be beneficial in circumstances in which the user is not yet familiar with the various UI design elements of the manufactured dataset generation UI and/or has trouble interpreting more nuanced requirements via the manufactured dataset generation UI.

The term “query” refers to a textual string of code, that, when executed, is configured to query one or more databases (e.g., e.g., a modified dataset library and one or more additional remote data sources) and return data specified by the query. A query may include elements including native commands associated with a query language in which the query is written. The elements may also include references to particular databases, tables, records, fields and/or the like from which the query is requesting data be returned. In some embodiments, a query may be generated based at least on a portion of data manufacture requirements contained in a user input set that is provided to the manufactured dataset generation system (e.g., by way of a manufactured dataset generation UI as discussed above). It is to be appreciated that the example operations described herein are not confined to particular types of queries and may be carried out using queries written in any query language.

### Overview

As noted above, methods, apparatuses, systems, and computer program products are described herein that provide for the generation and management of manufactured datasets. Traditionally, generation of manufactured data (e.g., synthetic data, obfuscated data, etc.) has been a complex process that requires extensive knowledge of certain data, modeling techniques, and/or highly technical data requirements. These traditional processes force teams of individuals to articulate various needs for manufactured data clearly. However, without a centralized and/or visual means of communication, information may become lost or unclear, resulting in the generation of unsuitable manufactured data. Further, as mentioned herein, the rigid and complex requirements of these conventional manufactured data generation processes leave less advanced users who may need to generate manufactured data unable to effectively do so.

Example embodiments herein provide a technical solution to the issues described above in the form of a manufactured dataset generation system that implements a platform (e.g., a Software-as-a-Service (SaaS) platform) providing a modified data generation UI with which users can easily interact to define requirements for a desired manufactured data set and that will subsequently automatically generate a suitable manufactured dataset according to the requirements. Further, the manufactured dataset generation system may also provide a highly secured, organized, and interactive manufactured dataset library which users may browse to review and/or retrieve previously generated manufactured datasets for use in various modeling applications. In some embodiments, manufactured datasets stored in the manufactured dataset library are secured via one or more security restrictions, which may be based on a sensitivity level of the manufactured datasets and/or the data from which the manufactured datasets were generated. In various embodiments, the manufactured dataset generation system and the manufactured dataset library operate under a “privacy first” implementation by ensuring specific tools (discussed further herein) are in place to effectively protect sensitive data and comply with various rules and regulations set forth by governing authoritative bodies or the like. Various security restrictions that may be implemented for one or more manufactured datasets of the manufactured dataset library include, but are not limited to, proximity restrictions, time restrictions, and/or user type restrictions, each of which are further discussed herein.

Additionally, in some embodiments, the manufactured dataset library allows for social engagement between users by providing various feedback loop mechanisms which enable users to submit ratings and user comments (e.g., reviews, issues, and/or other details) regarding the manufactured datasets which are viewable by other users (who may also submit replies to said comments). These social aspects set forth by the feedback loop mechanisms may enable users to gain additional insights (e.g., user perspectives) into a manufactured dataset before deciding to utilize the manufactured dataset for a particular application.

Further, in some embodiments, the manufactured dataset generation system may enable testing of the manufactured data (e.g., via model building and testing). In some embodiments, the manufactured dataset generation system may enable real-time generation and delivery of manufactured data without intermediate storage of the manufactured data, thereby permitting generation of manufactured data from sensitive source data without compromising security of the sensitive source data.

The manufactured dataset generation system may enable time-to-generate tradeoffs (and may visualize time-to-generate estimates for the user based on the user selections). In addition, as mentioned above, the manufactured dataset generation system may store previously generated manufactured data sets (e.g., in a manufactured dataset library) that can be used as source data from which user-specific manufactured datasets are generated. In some embodiments, the manufactured dataset generation system may be hosted by a large entity (e.g., an organization, corporation, financial institution, or the like) that has significant volumes of real information, thereby offering a data advantage to users of the system over manufactured data provided from other sources.

Although a high-level explanation of the operations of example embodiments has been provided above, specific details regarding the configuration of such example embodiments are provided below.

### System Architecture

Example embodiments described herein may be implemented using a variety of computing devices or servers. To this end, FIG. 1 illustrates an example environment 100 within which various embodiments may operate. As illustrated, a manufactured dataset generation system 102 may include a system device 104 in communication with a storage device 106 and a manufactured dataset library 108. Although system device 104, storage device 106, and manufactured dataset library 108 are described in singular form, some embodiments may utilize more than one system device 104, more than one storage device 106, and/or more than one manufactured dataset library 108. In some embodiments, the manufactured dataset generation system 102 may not require a storage device 106. Whatever the implementation, the manufactured dataset generation system 102, and its constituent system device(s) 104 and/or storage device (s) 106 and/or manufactured dataset library 108 may receive and/or transmit information via communications network(s) 110 (e.g., the Internet) with any number of other devices, such as one or more client devices 112A-112N and/or remote data sources 114A-114N.

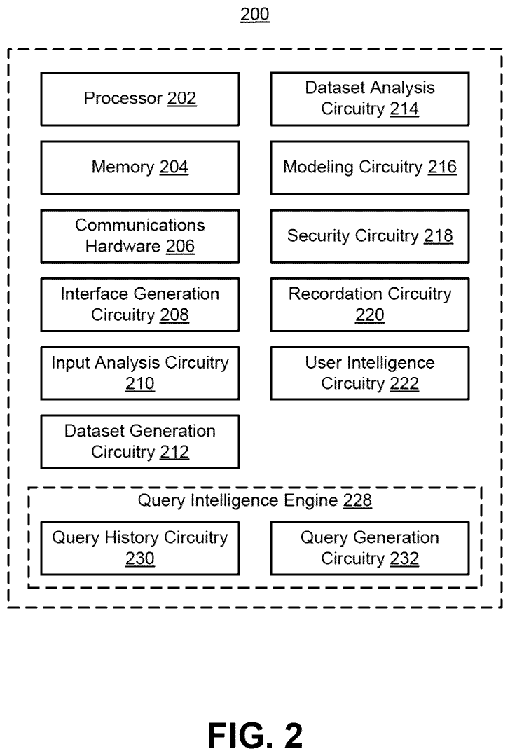

System device 104 may be implemented as one or more servers, which may or may not be physically proximate to other components of manufactured dataset generation system 102. Furthermore, some components of system device 104 may be physically proximate to the other components of manufactured dataset generation system 102 while other components are not. System device 104 may receive, process, generate, and transmit data, signals, and electronic information to facilitate the operations of the manufactured dataset generation system 102. Particular components of system device 104 are described in greater detail below with reference to apparatus 200 in connection with FIG. 2.

Storage device 106 and the manufactured dataset library 108 may comprise a distinct component from system device 104, or may comprise an element of system device 104 (e.g., memory 204, as described below in connection with FIG. 2). Storage device 106 and the manufactured dataset library 108 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 110). Storage device 106 may host the software executed to operate the manufactured dataset generation system 102. Storage device 106 may store information relied upon during operation of the manufactured dataset generation system 102, such as various models (e.g., machine learning (ML) models, artificial intelligence (AI) models, and/or the like) that may be used by the manufactured dataset generation system 102, data related to user input sets and/or user access requests, data and documents to be analyzed using the manufactured dataset generation system 102, various user data, and/or the like. In addition, storage device 106 may store control signals, device characteristics, and access credentials enabling interaction between the manufactured dataset generation system 102 and one or more of the client devices 112A-112N and/or remote data sources 114A-114N. The manufactured dataset library 108 may host manufactured datasets generated by the manufactured dataset system 102. The manufactured dataset library 108 may implement a plurality of different security mechanisms to protect manufactured datasets stored in the manufactured dataset library 108. Manufactured datasets stored in the manufactured dataset library 108 may be indexed or otherwise organized according to various data (e.g., metadata) regarding the manufactured datasets.

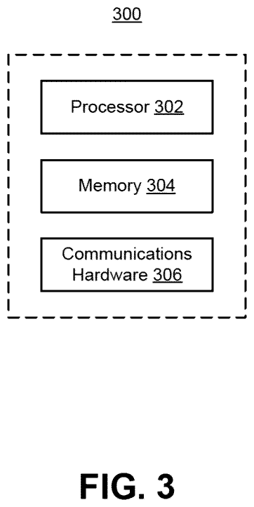

The one or more remote data sources 114A-114N may be embodied by any storage devices known in the art. Similarly, the one or more client devices 112A-112N may be embodied by any computing devices known in the art, such as desktop or laptop computers, tablet devices, smartphones, or the like. The one or more client devices 112A-112N and the one or more remote data sources 114A-114N need not themselves be independent devices, but may be peripheral devices communicatively coupled to other computing devices. Particular components of an example client device (e.g., client device 112A) are described in greater detail below with reference to apparatus 300 in connection with FIG. 3.

Although FIG. 1 illustrates an environment and implementation in which the manufactured dataset generation system 102 interacts with one or more client devices 112A-112N and/or one or more remote data sources 114A-114N, in some embodiments users may directly interact with the manufactured dataset generation system 102 (e.g., via input/output circuitry of system device 104), in which case a separate client device 112A may not be utilized. Whether by way of direct interaction or via a separate client device 112, a user may communicate with, operate, control, modify, or otherwise interact with the manufactured dataset generation system 102 to perform the various functions and achieve the various benefits described herein.

### Example Implementing Apparatuses

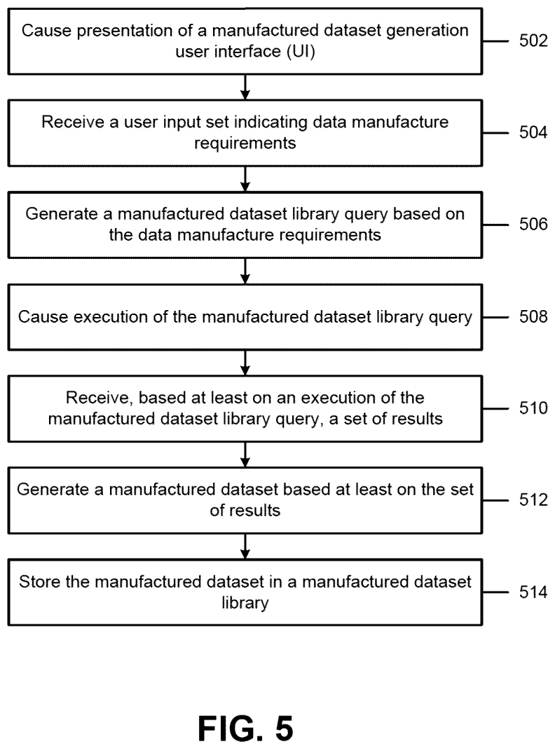

System device 104 of the manufactured dataset generation system 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, interface generation circuitry 208, input analysis circuitry 210, dataset generation circuitry 212, dataset analysis circuitry 214, modeling circuitry 216, security circuitry 218, recordation circuitry 220, user intelligence circuitry 222, and a query intelligence engine 224, which may include query history circuitry 230 and query generation circuitry 232, each of which will be described in greater detail below. The various components illustrated in FIG. 2 may each be connected with processor 202, though in some embodiments, the apparatus 200 may further comprises a bus (not expressly shown in FIG. 2) for passing information amongst any combination of the various components of the apparatus 200. The apparatus 200 may be configured to execute various operations described above in connection with FIG. 1 and below in connection with FIGS. 5-10.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises interface generation circuitry 208 that generates a manufactured dataset generation user interface (UI) and other various user interfaces associated with the manufactured dataset generation system 102. The interface generation circuitry 208 may utilize processor 202, memory 204, or any other hardware component included in the apparatus 200 to perform these operations, as described in connection with at least FIGS. 5-10 below. The interface generation circuitry 208 may further utilize communications hardware 206 to gather data from a variety of sources (e.g., client devices 112A-112N, remote data sources 114A-114N, and/or storage device 106, as shown in FIG. 1) and/or to receive data from a user, and in some embodiments may utilize processor 202 and/or memory 204 to configure and generate a manufactured dataset generation UI (e.g., based on user credential information, as further described herein) and other UIs associated with the manufactured dataset generation system 102.

In addition, the apparatus 200 further comprises input analysis circuitry 210 that analyzes a user input set to identify data manufacture requirements. The input analysis circuitry 210 may utilize processor 202, memory 204, or any other hardware component included in the apparatus 200 to perform these operations, as described in connection with FIGS. 5-10 below. The input analysis circuitry 210 may further utilize communications hardware 206 to gather data from a variety of sources (e.g., client devices 112A-112N and/or storage device 106, as shown in FIG. 1), and/or exchange data with a user, and in some embodiments may utilize processor 202 and/or memory 204 to identify data manufacture requirements by analyzing a user input set, for example, using one or more Natural Language Processing (NLP) techniques.

In addition, the apparatus 200 further comprises dataset generation circuitry 212 that generates a manufactured dataset based on a set of results (e.g., retrieved data such as one or more other datasets). The dataset generation circuitry 212 may utilize processor 202, memory 204, or any other hardware component included in the apparatus 200 to perform these operations, as described in connection with FIGS. 5-10 below. The dataset generation circuitry 212 may further utilize communications hardware 206 to gather data from a variety of sources (e.g., client devices 112A-112N, remote data sources 114A-114N, and/or storage device 106, as shown in FIG. 1), and in some embodiments may utilize processor 202 and/or memory 204 to generate a manufactured dataset based on a set of results and/or automatically update a manufactured dataset based on new or updated data associated with the manufactured dataset library 108 and/or one or more remote data sources 114A-114N.

In addition, the apparatus 200 further comprises dataset analysis circuitry 214 that identifies manufactured datasets within the manufactured dataset library 108 based on a manufactured dataset library query. The dataset analysis circuitry 214 may utilize processor 202, memory 204, or any other hardware component included in the apparatus 200 to perform these operations, as described in connection with FIGS. 5-10 below. The dataset analysis circuitry 214 may further utilize communications hardware 206 to gather data from a variety of sources (e.g., client devices 112A-112N, remote data sources 114A-114N, and/or storage device 106, as shown in FIG. 1), and in some embodiments may utilize processor 202 and/or memory 204 to identify one or more manufactured datasets of the manufactured dataset library based on a manufactured dataset library query (e.g., according to one or more data manufacture requirements set forth by the query, as further discussed herein).

In addition, the apparatus 200 further comprises modeling circuitry 216 that determines a predicted location set indicating one or more data locations from which to retrieve data likely to satisfy a portion of data manufacture requirements. The modeling circuitry 216 may utilize processor 202, memory 204, or any other hardware component included in the apparatus 200 to perform these operations, as described in connection with FIGS. 5-10 below. The modeling circuitry 216 may further utilize communications hardware 206 to gather data from a variety of sources (e.g., manufactured dataset library 108, client devices 112A-112N, remote data sources 114A-114N, and/or storage device 106, as shown in FIG. 1), and in some embodiments may utilize processor 202 and/or memory 204 to determine a predicted location set indicating one or more data locations from which to retrieve data likely to satisfy a portion of the data manufacture requirements. In some embodiments, the modeling circuitry 216 may comprise a model (or multiple models), such as a machine learning (ML) model (e.g., supervised or unsupervised ML model(s)), artificial intelligence (AI) reasoning model, and/or the like which is utilized to generate output data (e.g., predicted output in the form of a predicted location set) based on corresponding input data (e.g., data manufacture requirements) provided to the model.

In addition, the apparatus 200 further comprises security circuitry 218 that applies one or more security restrictions to a manufactured dataset. The security circuitry 218 may utilize processor 202, memory 204, or any other hardware component included in the apparatus 200 to perform these operations, as described in connection with FIGS. 5-10 below. The security circuitry 218 may further utilize communications hardware 206 to gather data from a variety of sources (e.g., manufactured dataset library 108, client devices 112A-112N, remote data sources 114A-114N, and/or storage device 106, as shown in FIG. 1), and in some embodiments may utilize processor 202 and/or memory 204 to apply one or more security restrictions to manufactured datasets (e.g., manufactured datasets stored in manufactured dataset library 108). In some embodiments the security circuitry 218 may also utilize processor 202 and/or memory 204 to grant or deny access to one or more manufactured datasets based on one or more security restrictions (as further discussed herein).

In addition, the apparatus 200 further comprises recordation circuitry 220 that generates a transaction log for a manufactured dataset. The recordation circuitry 220 may utilize processor 202, memory 204, or any other hardware component included in the apparatus 200 to perform these operations, as described in connection with FIGS. 5-10 below. The recordation circuitry 220 may further utilize communications hardware 206 to gather data from a variety of sources (e.g., manufactured dataset library 108, client devices 112A-112N, remote data sources 114A-114N, and/or storage device 106, as shown in FIG. 1), and in some embodiments may utilize processor 202 and/or memory 204 to generate transaction logs for manufactured datasets (e.g., manufactured datasets stored in manufactured dataset library 108).

In addition, the apparatus 200 further comprises user intelligence circuitry 222 that determines one or more users of a manufactured dataset library that satisfy a project similarity threshold to a first user and also determines one or more previously generated manufactured datasets associated with the identified user(s). The user intelligence circuitry 222 may utilize processor 202, memory 204, or any other hardware component included in the apparatus 200 to perform these operations, as described in connection with FIGS. 5-10 below. The user intelligence circuitry 222 may further utilize communications hardware 206 to gather data from a variety of sources (e.g., manufactured dataset library 108, client devices 112A-112N, remote data sources 114A-114N, and/or storage device 106, as shown in FIG. 1), and in some embodiments may utilize processor 202 and/or memory 204 to determine, based at least on data manufacture requirements, one or more users of the manufactured dataset library that satisfy a project similarity threshold (as further discussed herein).

In addition, the apparatus further comprises a query intelligence engine 228 that is configured to generate and manage queries utilized by the manufactured dataset generation system 102. The query intelligence engine 228 comprises query history circuitry 230 that stores manufactured datasets and various data in association with the manufactured datasets, and compares sets of data manufacture requirements to identify previously generated and stored queries. The query history circuitry 230 may utilize processor 202, memory 204, or any other hardware component included in the apparatus 200 to perform these operations, as described in connection with FIGS. 5-10 below. The query history circuitry 230 may further utilize communications hardware 206 to gather data from a variety of sources (e.g., manufactured dataset library 108, client devices 112A-112N, remote data sources 114A-114N, and/or storage device 106, as shown in FIG. 1), and in some embodiments may utilize processor 202 and/or memory 204 to store manufactured datasets and various data in association with the manufactured datasets, and compare sets of data manufacture requirements to identify previously generated and stored queries.

The query intelligence engine 228 also comprises query generation circuitry 232 that generates queries based on dataset manufacture requirements and causes execution of the queries. The query generation circuitry 232 can also identify portions of data manufacture requirements that are not satisfied based on results of a first query and generates one or more additional queries directed to other data sources (e.g., remote data sources 114A-114N). The query generation circuitry 232 may utilize processor 202, memory 204, or any other hardware component included in the apparatus 200 to perform these operations, as described in connection with FIGS. 5-10 below. The query generation circuitry 232 may further utilize communications hardware 206 to gather data from a variety of sources (e.g., manufactured dataset library 108, client devices 112A-112N, remote data sources 114A-114N, and/or storage device 106, as shown in FIG. 1), and in some embodiments may utilize processor 202 and/or memory 204 to generate and cause execution of queries based on dataset manufacture requirements.

Although components 202-232 are described in part using functional language, it will be understood that the particular implementations necessarily include the use of particular hardware. It should also be understood that certain of these components 202-232 may include similar or common hardware. For example, the interface generation circuitry 208, input analysis circuitry 210, dataset generation circuitry 212, dataset analysis circuitry 214, modeling circuitry 216, security circuitry 218, recordation circuitry 220, user intelligence circuitry 222, and the query intelligence engine 228 that includes query history circuitry 230 and query generation circuitry 232 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the interface generation circuitry 208, input analysis circuitry 210, dataset generation circuitry 212, dataset analysis circuitry 214, modeling circuitry 216, security circuitry 218, recordation circuitry 220, user intelligence circuitry 222, and the query intelligence engine 228 that includes query history circuitry 230 and query generation circuitry 232 may leverage processor 202, memory 204, or communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, or communications hardware 206 for enabling any functions not performed by special-purpose hardware elements. In all embodiments, however, it will be understood that the interface generation circuitry 208, input analysis circuitry 210, dataset generation circuitry 212, dataset analysis circuitry 214, modeling circuitry 216, security circuitry 218, recordation circuitry 220, user intelligence circuitry 222, and the query intelligence engine 228 that includes query history circuitry 230 and query generation circuitry 232 are implemented via particular machinery designed for performing the functions described herein in connection with such elements of apparatus 200.

As illustrated in FIG. 3, an apparatus 300 is shown that represents an example client device (e.g., any of client devices 112A-112N). The apparatus 300 includes processor 302, memory 304, and communications hardware 306, each of which is configured to be similar to the similarly named components described above in connection with FIG. 2.

In some embodiments, various components of the apparatuses 200 and 300 may be hosted remotely (e.g., by one or more cloud servers) and thus need not physically reside on the corresponding apparatus 200 or 300. Thus, some or all of the functionality described herein may be provided by third party circuitry. For example, a given apparatus 200 or 300 may access one or more third-party circuitries via any sort of networked connection that facilitates transmission of data and electronic information between the apparatus 200 or 300 and the third-party circuitries. In turn, that apparatus 200 or 300 may be in remote communication with one or more of the other components describe above as comprising the apparatus 200 or 300.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of graphical user interfaces and flowcharts.

### Example Manufactured Dataset Generation User Interface

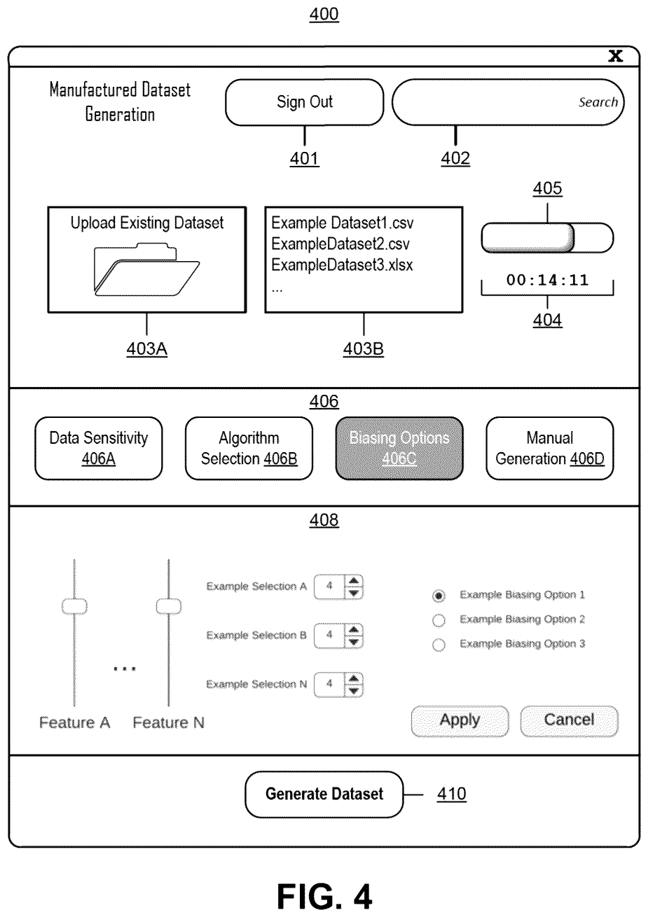

Turning to FIG. 4, a graphical user interface (GUI) is provided that illustrates an example manufactured dataset generation UI 400. As noted previously, a user may interact with the manufactured dataset generation system 102 by directly engaging with communications hardware 206 of an apparatus 200 comprising a system device 104 of the manufactured dataset generation system 102. In such embodiments, the manufactured dataset generation UI 400 shown in FIG. 4 may be displayed to a user by the apparatus 200. Alternatively, a user may interact with the manufactured dataset generation system 102 using a separate client device (e.g., any of client devices 112A-112N, as shown in FIG. 1), which may communicate with the manufactured dataset generation system 102 via communications network 110. In such an embodiment, the manufactured dataset generation UI 400 shown in FIG. 4 may be displayed to the user by the client device.

In some embodiments, the manufactured dataset generation UI 400 may be displayed and accessed by a user via a web browser. In some embodiments, the manufactured dataset generation UI 400 may be displayed and accessed by a user via a standalone application (e.g., a desktop app, a mobile app, or the like). As shown in FIG. 4, the manufactured dataset generation UI 400 may comprise a plurality of manufactured data generation UI elements (further described below) that may include various buttons, fillable fields, selectable icons, indicators, sliders, and/or other types of user interface elements. The manufactured data generation UI elements may be interacted with by a user via communications hardware 206 (e.g., a keyboard, mouse, etc.). In some embodiments, the manufactured data generation UI elements may be interacted with by a user via a touch display (e.g., at a client device 112A, such as a mobile phone, tablet, or the like).

In some embodiments, a user input set that indicates data manufacture requirements needed by a user may be received by the manufactured dataset generation system 102 based on the user interacting with the various manufactured data generation UI elements of the manufactured dataset generation UI 400. In other words, the user may be enabled to explicitly define their requirements for a desired manufactured dataset via the manufactured dataset generation UI 400. In this regard, the apparatus 200 includes means, such as processor 202, memory 204, communications hardware 206, and/or the like, for receiving a user input set indicating data manufacture requirements based on user interactions with a plurality of manufactured data generation UI elements of a manufactured dataset generation UI. The user input set may comprise a collection of user input indications received by way of the manufactured dataset generation UI. For example, a user input indication may indicate a selection of one of several options for a particular element, an uploaded file or a pointer to an uploaded file, manual text input, one or more audio files, and/or the like, as further described herein.

As shown in FIG. 4, for example, the manufactured dataset generation UI 400 may include a sign out button 401 enabling the user to sign out of their registered user account of the manufactured dataset generation system 102 (or of an organization that manages or is otherwise associated with the manufactured dataset generation system 102). The manufactured dataset generation UI 400 may also include a search field 402 that enables a user to search for various tools or features within the manufactured dataset generation UI 400.

In some embodiments, the manufactured dataset generation UI 400 may also include a dataset upload button 403A, that, when (optionally) selected by a user, may enable the user to upload or provide a pointer to a known existing dataset to be used in the generation of a manufactured dataset. The existing dataset may be known to the user in that the user may wish to have a manufactured dataset (e.g., a synthetic dataset) be generated based on the existing dataset. The existing dataset may be an authentic dataset or a manufactured dataset such as a fully or partially synthetic dataset or a fully or partially obfuscated dataset. This option for the user to upload a known existing dataset may serve to both expedite the process of generating new manufactured data and to offer the ability to harmonize the characteristics of new manufactured data with the characteristics of existing authentic and/or manufactured data (e.g., where expansion or modification of an existing dataset known to the user is desired). In this regard, in some embodiments, the manufactured dataset generation system 102 may generate a manufactured dataset using an uploaded dataset as a source dataset, or in other words, generate a synthetic dataset that mimics an uploaded dataset or obfuscates (e.g., masks, tokenizes, anonymizes, etc.) an uploaded dataset. In various embodiments (and as further discussed herein), a user need not necessarily upload an existing dataset. Rather, the manufactured dataset generation system 102 may automatically retrieve one or more datasets (e.g., from a manufactured dataset library 108 and/or one or more remote data sources 114A-114N) to utilize for generating a manufactured dataset according to data manufacture requirements defined by the user (e.g., via the manufactured dataset generation UI 400).

In some embodiments, the manufactured dataset generation UI 400 may include a dataset upload indication element 403B that lists filenames of the existing datasets as the datasets are input by the user. As shown, an example user has input three authentic datasets, “ExampleDataset1.csv,” “ExampleDataset2.csv,” and “ExampleDataset3.xlsx.” Though FIG. 4 depicts uploaded datasets as .CSV (comma-separated values) and .XLSX (Microsoft Excel Open XML (Extensible Markup Language) Spreadsheet) file types, it is to be appreciated that other file types may be recognized and/or processed by the manufactured dataset generation system 102. In some embodiments, the existing dataset may not be immediately uploaded to the manufactured dataset generation system 102. For example, the existing dataset may be stored on a client device 112A of the user that is interacting with the manufactured dataset generation system 102 using the client device 112A. The existing dataset may contain sensitive data points that the user may not be willing to upload to the manufactured dataset generation system 102 avoid the risk of exposure during transmission. In this regard, any dataset input via the dataset upload button 403A may not be uploaded to the manufactured dataset generation system 102 until the generate dataset button 410 is selected (as described further below).

In some embodiments, the manufactured dataset generation UI 400 may enable a user to review previously generated manufactured datasets that have been generated by the manufactured dataset generation system 102, e.g., via the manufactured dataset library 108. For example, as further discussed herein, the previously generated manufactured datasets that have been generated by the user and/or other users may be cataloged and stored by the manufactured dataset generation system 102 in the manufactured dataset library 108. In some embodiments, the manufactured dataset generation UI 400 may provide the ability for a user to not allow a manufactured dataset to be stored in the manufactured dataset library and/or accessible by other users (e.g., in cases in which the synthetic dataset mimics extremely sensitive authentic data or other similar situations). In this case, once a manufactured dataset is generated for the user, the user may export the manufactured dataset without having the manufactured dataset saved to the manufactured dataset library 108.

The example manufactured dataset generation UI 400 may include a first pane 406 comprising a plurality of selectable buttons 406A through 406D that cause corresponding changes to manufactured data generation UI elements displayed in pane 408 that, in turn, enable a user to further define various data manufacture requirements such as features, metadata, parameters, and/or the like of a desired manufactured dataset. Although four selectable buttons 406A-406D are shown, it is to be appreciated that the manufactured dataset generation UI 400 may include additional (or fewer) selectable buttons. In this example of the manufactured dataset generation UI 400 shown in FIG. 4, a user has selected the biasing options button 406C, as evidenced by the darker shade of the biasing options button 406C compared with the other buttons 406A, 406B, and 406D.

Any specific implementation of the manufactured dataset generation UI 400 will leverage a series of predefined associations between sets of manufactured data generation UI elements and corresponding selectable buttons 406A-406D (and/or other selectable buttons). Accordingly, upon selection of one of the selectable buttons 406A-406D, one or more manufactured data generation UI elements associated with the selected button may be displayed in pane 408. For instance, FIG. 4 shows an example implementation in which selection of the biasing options button 406C causes various manufactured data generation UI elements to be displayed within pane 408. The synthetic data generation UI elements that are shown in FIG. 4 as being displayed in pane 408 may include various sliders, menus, radio buttons, and/or other elements that enable a user to define various data manufacture requirements for a desired manufactured dataset prior to generation of the manufactured dataset.

As shown by the pane 408 in FIG. 4, in some embodiments, a user may select a degree of bias that may affect a statistical distribution of data points in a generated manufactured dataset. In this regard, the user input set may comprise an indication of a selected degree of bias. As a simple example, in a case in which a user needs the system to generate a synthetic dataset related to a human population, a degree of bias may be selected such that the synthetic dataset may have more data points regarding females than data points regarding males. Upon generating the synthetic dataset (as described further below), data points may be generated for the synthetic dataset according to the selected degree of bias (e.g., additional female data points may be generated). In this regard, the apparatus 200 includes means, such as processor 202, memory 204, dataset generation circuitry 212, or the like, for generating, by the dataset generation circuitry, a plurality of data points of a manufactured dataset based on the selected degree of bias.

The manufactured dataset generation UI elements that are displayed in pane 408 as shown in FIG. 4 may also include other various options for defining various properties and other requirements of a manufactured dataset. For example, types of statistical distributions to base the manufactured dataset on, degree of class separation, number of features, length of the dataset, and/or the like may all be selected via the manufactured dataset generation UI elements displayed in pane 408.

In some embodiments, selection of the algorithm selection button 406B may cause new manufactured dataset generation UI elements, which may include an algorithm selection menu, to be displayed in pane 408 (e.g., replacing the manufactured dataset generation UI elements displayed in pane 408 of FIG. 4. In embodiments using this particular set of manufactured dataset generation UI elements, a user may select an algorithm of their choice to be used to generate a synthetic dataset by the synthetic data generation system 102. In this regard, the user input set received by the manufactured dataset generation system 102 may comprise a selection of one or more predefined manufactured data generation algorithms. For instance, a user may select one or more predefined synthetic data generation algorithms and/or algorithms related to data obfuscation (e.g., data masking, scrambling, encryption, anonymization, etc.) via the algorithm selection menu to generate a user input indication indicating the selection of one or more predefined algorithms.

In some embodiments, the manufactured dataset generation UI 400 may be generated based on received user credential information. Additionally, in some embodiments and as further discussed herein, access to the manufactured dataset library 108 and/or various manufactured datasets stored in the dataset library may be limited based on user credential information. In this regard, the user may be identified as a specific type of user (e.g., a normal user, an advanced user, etc.) such that the manufactured dataset generation system 102 may generate the manufactured dataset generation UI 600 to be tailored to the specific type of user. For instance, in some embodiments, depending on the type of user, certain manufactured dataset generation UI elements of the manufactured dataset generation UI 400 may be unavailable to interact with by the user. In this regard, the apparatus 200 includes means, such as processor 202, memory 204, interface generation circuitry 208, or the like, for disabling one or more manufactured dataset data generation UI elements based on the user credential information.

As one example, algorithm selection may only be available to more advanced (e.g., more knowledgeable, or more experienced) users (e.g., data scientists and/or others who have a better understanding of the various predefined algorithms). In this regard, less advanced users may be unable to select algorithms from the algorithm selection menu and instead, a default algorithm choice may be applied by the manufactured dataset generation system 102. In this regard, the apparatus 200 includes means, such as processor 202, memory 204, interface generation circuitry 208, or the like, for automatically applying default settings to one or more manufactured dataset data generation UI elements based on the user credential information. For example, if a user is unable to utilize the algorithm selection features based on their user credential information, an alert message may be displayed upon a user selecting the algorithm selection button 406B. The alert message may indicate that the particular feature (in this case, algorithm selection) is deactivated for the user's account. Additionally, the algorithm selection button 406B may be grayed out and deactivated such that the user is unable to select the algorithm selection button 406B. However, in some embodiments, the default setting (e.g., the default algorithm to be used to generate the manufactured dataset) may be visually presented such that the user is informed as to the type of algorithm(s) that will be used to generate their manufactured dataset.

In some embodiments, upon selection of the manual generation button 406D, one or more manufactured dataset generation UI elements related to manual user generation of data points may be displayed in pane 408. For instance, rather than using one or more algorithms to automatically generate certain values for various fields associated with (e.g., synthetic) data points, the manufactured dataset generation UI 400 may enable a user to manually enter values for the fields associated with one or more data points to be included in a manufactured dataset. In this regard, an interactive table may be displayed that allows a user to create and further define various data points and features of said data points to be included in a manufactured dataset to be generated by the manufactured dataset generation system 102.

In some embodiments, upon selection of the data sensitivity button 406A, one or more manufactured dataset generation UI elements related to a data sensitivity level of a generated manufactured dataset may be displayed in pane 408. Through interacting with these manufactured dataset generation UI elements, a user may define a data sensitivity level (or multiple data sensitivity levels) for a manufactured dataset. In this regard, when dealing with sensitive authentic data that requires a high level of privacy (e.g., an authentic dataset uploaded via the dataset upload button 403A), a user may set a higher data sensitivity level for the generated manufactured dataset. A higher data sensitivity level results in data points of a generated manufactured dataset being obfuscated from the source authentic data to a greater degree (e.g., no synthetic data points in a generated synthetic dataset will directly match any authentic data points in an uploaded authentic dataset). A lower data sensitivity level may result in some synthetic data points matching some authentic data points in the uploaded authentic dataset. In this regard, the user input set may comprise a data sensitivity level indication based on the user's preference of data sensitivity.

As shown in FIG. 4, the example manufactured dataset generation UI 400 may also include a time-to-generate estimation indicator 404. In this regard, in some embodiments, the manufactured dataset generation system 102 may determine an estimated time required to fully generate a manufactured dataset (e.g., including retrieval of one or more datasets from various sources such as dataset library 108 and/or one or more remote data sources 114A-114N) based on a received user input set that defines data manufacture requirements and various parameters for the desired manufactured dataset. In this regard, the apparatus 200 includes means, such as processor 202, memory 204, input analysis circuitry 210, or the like, for determining, based on a user input set, a time-to-generate estimation for a manufactured dataset. In this regard, more complex user input sets (e.g., having multiple uploaded source datasets, audio and/or text data outlining various data manufacture requirements, more complex options selected, greater data sensitivity settings, etc.) may result in a greater time-to-generate estimation than less complex user input sets. The apparatus 200 also includes means, such as processor 202, memory 204, communications hardware 206, or the like, for causing presentation of an indication of the time-to-generate estimation. As shown in FIG. 4, the time-to-generate estimation may be displayed as a time-to-generate estimation indicator 404, which may include a number of hours, minutes, and/or seconds estimated to be required to generate the synthetic dataset.

Advantageously, the time-to-generate estimation may be continuously determined and updated in real-time as a user interacts with the manufactured dataset generation UI 400. In this regard, as a user makes various selections via the manufactured dataset generation UI elements of the manufactured dataset generation UI 400, the time-to-generate estimation may be continuously re-assessed by the manufactured dataset generation system 102 to reflect a more accurate time estimation. By consistently displaying an up-to-date time-to-generate estimation in real-time, a user may be made aware not only of the time needed to generate a manufactured dataset, but also of how much computational power and/or resources are being utilized to generate the manufactured dataset. In this regard, a higher time-to-generate estimation may inform the user on their computational resource usage and cause the user to make decisions to reduce their computational resource usage through changing one or more settings via the manufactured dataset generation UI 400 or the like.

In this regard, the apparatus includes means, such as processor 202, memory 204, input analysis circuitry 210, or the like, for updating the time-to-generate estimation in real-time. In this regard, the manufactured dataset generation system 102 may factor an updated or additionally received user input indication into a determination of the time-to-generate estimation to more accurately reflect a time required to generate the manufactured dataset. For instance, if the user has uploaded an additional source dataset, the time-to-generate estimation may be increased based on the size of the uploaded source dataset. As another example, if the user has selected a lower data sensitivity level, the time-to-generate estimation may be lowered (e.g., by having a lower data sensitivity level, less synthetic data points may need to be generated for a new synthetic dataset, and instead, some data points of an uploaded authentic dataset and/or previously generated dataset may be able to be reused for the new synthetic dataset). The apparatus 200 also includes means, such as processor 202, memory 204, communications hardware 206, or the like, for causing presentation of an updated time-to-generate estimation. As mentioned above, an updated time-to-generate estimation may be generated in real-time, such that the updated time-to-generate estimation may be presented in real-time in response to user interactions with the manufactured dataset generation UI 400.

As shown in FIG. 4, the example manufactured dataset generation UI 400 may also include a generate dataset button 410. As further discussed below, selection of the generate dataset button 410 may initiate a process of generating a manufactured dataset for the user and, in some embodiments, indexing and storing the manufactured dataset in the manufactured dataset library 108. For example, as detailed herein, upon selection of the generate dataset button 410, one or more queries may be built and executed in order to retrieve data needed to generate the manufactured dataset. Additionally, selection of the generate dataset button 410, a user input set may be analyzed to identify various data manufacture requirements expressed by the user via the user input set. This may involve processing audio or text data (e.g., submitted as part of the user input set via the manufactured dataset generation UI 400) using various techniques, such as Natural Language Processing (NLP) and/or the like. The selection of the generate dataset button 410 may also cause any existing source datasets that were input via the dataset upload button 403A to be automatically uploaded to the manufactured dataset generation system 102 and processed to generate a manufactured dataset.

As shown in FIG. 4, the manufactured dataset generation UI 400 may include a progress bar 405 that visualizes progress of the generation of a user input set. This progress bar may visually indicate a fraction of the manufactured data generation steps that have been completed by the user (e.g., using a two-color graphic illustrating the completed fraction via expansion of one color across the progress bar, interpretable in the manner of a thermometer). In some embodiments, this visual indication may be accompanied by a completion percentage displayed above or below the progress bar 405. The progress bar 405 may be automatically updated each time a user has entered data into a field or taken another action indicating completion of a field. The percentage of the progress bar in one of the colors may correspond to the percentage of the fields for which data is entered (or that are indicated as complete). In a more complex implementation, each field has a corresponding weight, such that completion of some field will cause larger changes in the progress bar than completion of other fields. In some embodiments, upon selection of the generate dataset button 410, the progress bar 405 may be displayed and updated in conjunction with the time-to-generate estimation indicator 404. Further, upon selection of the generate dataset button 410, the time-to-generate estimation may begin visually counting down (e.g., counting down to zero (0) in hours, minutes, seconds) until generation of the manufactured dataset is completed.

### Example Operations

Turning to FIGS. 5-10, example flowcharts are illustrated that contain example operations implemented by example embodiments described herein. The operations illustrated in FIGS. 5-10 may, for example, be performed by system device 104 of the manufactured dataset generation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, interface generation circuitry 208, input analysis circuitry 210, dataset generation circuitry 212, dataset analysis circuitry 214, modeling circuitry 216, security circuitry 218, recordation circuitry 220, user intelligence circuitry 222, the query intelligence engine 228 that includes query history circuitry 230 and query generation circuitry 232, and/or any combination thereof. It will be understood that user interaction with the manufactured dataset generation system 102 may occur directly via communications hardware 206, or may instead be facilitated by a separate client device (e.g., any one of client devices 112A-112N as shown in FIG. 1), and which may have similar or equivalent physical componentry facilitating such user interaction.

Turning first to FIG. 5, example operations are shown for manufactured dataset generation and management. As shown by operation 502, the apparatus 200 includes means, such as processor 202, memory 204, communications hardware 206, or the like, for causing presentation of a manufactured dataset generation user interface (UI).

As discussed above, in some embodiments, the manufactured dataset generation UI may be generated and presented based on user credential information received by the manufactured dataset generation system 102. In this regard, the apparatus 200 may include means, such as processor 202, memory 204, communications hardware 206, and/or the like, for receiving user credential information. User credential information may comprise any type of data used to identify a user. For example, in some embodiments, user credential information may comprise a username and/or password. In some embodiments, user credential information may comprise a biometric identifier (or a combination of biometric identifiers) of a user, such as a retinal scan, fingerprint, voice capture, and/or the like. Regardless of the type of user credential information, the user credential information may be received in response to an attempt by a user to log in to the manufactured dataset generation system 102. As noted above, in some embodiments, a user may interact directly with the manufactured dataset generation system 102, such that the user credential input is received via direct input to communications hardware 206 of the manufactured dataset generation system 102. In other embodiments, a user may interact indirectly with the synthetic data generation system 102, such as remotely via communications hardware 306 of a client device (e.g., client device 112A). In this manner, the user credential information may be received via a communications network 110.

In some embodiments, the received user credential information may be analyzed to identify the user that is attempting to log in to the manufactured dataset generation system 102. For example, the user credential information may be compared with stored user credential information of registered users to determine whether the user credential information matches that of a registered user. In some embodiments, an entity such as an organization, corporation, or the like may manage the manufactured dataset generation system 102 as well as a plurality of registered users of the manufactured dataset generation system 102. For example, registered users of the manufactured dataset generation system 102 may include employees of the entity. In some embodiments, different levels of access to various features of the manufactured dataset generation system 102 and its manufactured dataset library 108 may be predefined for registered users of the manufactured dataset generation system 102. In this regard, more advanced users (e.g., data scientists or the like) may have access to certain features of the manufactured dataset generation system 102 and/or manufactured dataset library 108 that other, less advanced users do not. However, it is to be appreciated that in some embodiments, user login to the manufactured dataset system 102 may not be required at all and all features of the manufactured dataset generation system 102 may be available to any user.

The apparatus also includes means, such as processor 202, memory 204, interface generation circuitry 208, and/or the like, for generating the manufactured dataset generation UI. As discussed above the manufactured dataset generation UI may be generated and presented in response to the received user credential information matching that of a registered user. In other words, once the user is authorized in that the user is determined to be a registered user of the manufactured dataset generation system 102, the manufactured dataset generation UI may be generated and displayed (e.g., in accordance with feature access levels as defined by the user credential information).

As shown by operation 504, the apparatus 200 includes means, such as processor 202, memory 204, communications hardware 206, or the like, for receiving a user input set indicating data manufacture requirements. As discussed above in connection with FIG. 4, a user input set may comprise plurality of user input indications generated based on user interactions with the manufactured dataset generation UI elements of the manufactured dataset generation UI (e.g., indications that may indicate a selection of one of several options for a particular element, an uploaded file or a pointer to an uploaded file (e.g., a source dataset known to the user), and/or other data manufacture requirements defined by way of interactions with the manufactured dataset generation UI elements).

In some embodiments, the user input set may also include audio data and/or text data. For example, in some embodiments, the manufactured dataset generation system 102 may allow a user to provide audio data and/or text data via the manufactured dataset generation UI. Example text data may be provided in a text file and uploaded using an upload element of the manufactured dataset generation UI.

The example text data may include text outlining one or more data manufacture requirements (e.g., an existing document or the like that is related to a modeling project or application for which the user needs to generate a manufactured dataset). Similarly, example audio data may be provided in an audio file (which may be generated by the manufactured dataset generation system 102 in response to a user interacting with communications hardware 206 of the manufactured dataset generation system 102 or with communications hardware 306 of a client device (e.g., client device 112A)). The example audio data may include audio such as words spoken by the user and/or other users outlining one or more data manufacture requirements.

In some embodiments, the user input set may include text data and/or audio data in addition to one or more user input indications (generated based on user interactions with the manufactured dataset generation UI elements of the manufactured dataset generation UI). In other embodiments, the user input set may include text data and/or audio data without including any user input indications generated by way of the manufactured dataset generation UI. In this regard, a user may choose not to define their particular data manufacture requirements by interacting with the elements of the UI and instead may provide their own text data and/or audio data which the system 102 may then process to identify the data manufacture requirements.

The manufactured dataset generation system 102 may utilize one or more techniques to process text data and/or audio data in order to identify any and all data manufacture requirements set forth in the text data and/or audio data. For example, Natural Language Processing (NLP) techniques may be performed to parse the text data and/or audio data and accurately identify data manufacture requirements within. In this regard, the apparatus 200 includes means, such as processor 202, memory 204, input analysis circuitry 210, or the like, for identifying data manufacture requirements by analyzing an input set using one or more NLP techniques.

The NLP techniques may involve use of one or more trained models (e.g., artificial intelligence (AI) models, machine learning models, and/or the like) and techniques such as Automatic Speech Recognition (ASR). Through ASR, spoken audio may be transcribed into text by leveraging one or more NLP models such as an acoustic model (e.g., a model which turns sound signals into a phonetic representation) and a language model (e.g., a model that maps possible phonetic representations to words and sentence structure representing a given language). In some embodiments, the use of ASR may involve leveraging neural networks and deep learning to generate transcribed text more accurately and with little or no human supervision required.

The manufactured dataset generation system 102 may process text data (e.g., text data provided by the user in a user input set or text data transcribed from audio data as discussed above) with one or more text classification and/or extraction techniques. By using NLP, text classifiers may automatically analyze text and then assign a set of predefined tags or categories (which may correspond to predefined data manufacture requirements) based on its content. In some embodiments, text mining techniques may also be used to extract data manufacture requirements from the unstructured text data. Through one or a combination of these processes, the manufactured dataset generation system 102 may automatically identify specific data manufacture requirements set forth in audio data and/or text data provided by a user.

By allowing users to provide their own text data and/or audio data, several technical benefits are realized. For instance, new or inexperienced users who may be unfamiliar with the manufactured dataset generation system 102 and unsure if they can accurately articulate their particular data manufacture requirements via the manufactured dataset generation UI can instead provide text data and/or audio data which they know for certain expresses all of their data manufacture requirements. In this regard, both time and computational resources can be conserved by avoiding situations where users fail to define their requirements correctly via manufactured dataset generation UI elements and have to reperform the generation of a user input set (along with the generation and execution of one or more queries as further discussed below). Additionally, the ability to submit text data and/or audio data may benefit users with accessibility issues. Such users may find it easier to provide text data and/or audio data rather than interact with the various manufactured dataset generation UI elements of the manufactured dataset generation UI.

As discussed above, the user input set may comprise a plurality of data manufacture requirements for a desired manufactured dataset, which can include various requirements including (but not limited to) types of data, amounts of data, a size of the desired manufactured dataset (e.g., an estimated size in megabytes (MB), gigabytes (GB), terabytes (TB), or the like), field names, features, data sensitivity needs, bias information, algorithms, etc. In some embodiments, in addition to specific data manufacture requirements, the user may also be enabled to optionally specify a recency parameter.

A recency parameter indicates a preferred time period in which data to be used to generate the desired manufactured dataset was created and/or last updated. As one example, the recency parameter may indicate a requirement for data retrieved for the generation of a manufactured dataset to have been created or last updated within the previous 30 days (where possible). It is to be appreciated that other time periods may be specified in a recency parameter, such as time periods expressed in minutes, hours, months, and/or years. The recency parameter may be defined by the user via a manufactured dataset generation UI element of the manufactured dataset generation UI or identified by the manufactured dataset generation system 102 from a text file and/or audio file provided as part of the user input set.

In some embodiments, in addition to specific data manufacture requirements, the user may also be enabled to optionally specify a resource consumption parameter. A resource consumption parameter indicates a preference of the user as to an amount of computational resources that should be utilized to generate their desired manufactured dataset. Said differently, if the user wishes to trade off generation speed for a reduced or “greener” use of computational resources, the user may include a resource consumption parameter. However, if the user wishes to obtain a manufactured dataset that leverages a robust collection of datasets to build the manufactured dataset in a short amount of time, the user may not include a resource consumption parameter. In some embodiments, the ability to include a resource consumption parameter may be presented as a binary option (e.g., yes/no) within the manufactured dataset generation UI or, in some embodiments, the user may provide a custom resource consumption parameter (e.g., more nuanced instructions as to the generation of a desired manufactured dataset) via text data and/or audio data. By allowing users to indicate a resource consumption parameter, several technical benefits are realized. For instance, through use of a resource consumption parameter, computational resources (e.g., in the form of network transmissions and significant amounts of data retrieval) may be preserved thereby allowing the manufactured dataset generation system 102 to function in a greater capacity (e.g., exhibit improved generation speed of manufactured datasets) for all users who may be utilizing the manufactured dataset generation system 102 simultaneously.

As shown by operation 506, the apparatus 200 includes means, such as processor 202, memory 204, query generation circuitry 232, or the like, for generating a manufactured dataset library query based on the data manufacture requirements. The manufactured dataset library query may comprise a query specifically tailored to execute over the manufactured dataset library 108 in order to identify and retrieve previously generated manufactured datasets that can be used as a basis for or part of a desired manufactured dataset in accordance with the data manufacture requirements of the user input set. In other words, the manufactured dataset library query can serve as a “quick lookup” mechanism to identify whether manufactured data that corresponds to some or all of the data manufacture requirements has already been generated (and stored in the manufactured dataset library 108) and if so, that manufactured data can be retrieved for use in generating the user's desired manufactured dataset. By first identifying existing manufactured datasets from the manufactured dataset library 108 via the manufactured dataset library query, both computational resources and time can be saved by avoiding duplicative and redundant processes (such as querying one or more remote data sources (e.g., remote data sources 114A-114N) as further discussed below). As shown by operation 508, the apparatus 200 also includes means, such as processor 202, memory 204, query generation circuitry 232, or the like, for causing execution of the manufactured dataset library query. As shown by operation 510, the apparatus 200 also includes means, such as processor 202, memory 204, communications hardware 206, or the like, for receiving, based at least on an execution of the manufactured dataset library query, a set of results. The set of results may comprise one or more manufactured datasets or portions thereof (e.g., stored in the manufactured dataset library 108) having been previously generated based on one or more previously received user input sets. In some embodiments, the set of results may additionally (or alternatively) include manufactured data retrieved by executing one or more additional queries (e.g., one or more extended dataset queries further described below).

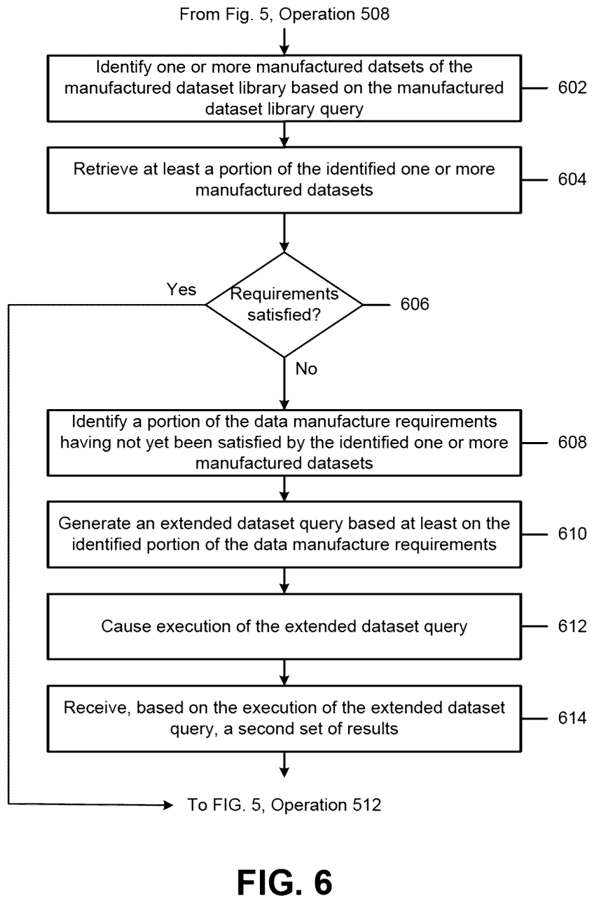

Turning briefly to FIG. 6, example operations related to acquiring a set of results are shown. These operations may occur in response to the execution of the manufactured dataset library query.

As shown by operation 602, the apparatus 200 includes means, such as processor 202, memory 204, dataset analysis circuitry 214, or the like, for identifying one or more manufactured datasets of the manufactured dataset library based on the manufactured dataset library query. In this regard, the manufactured dataset library query may be generated to include locations in memory (e.g., the manufactured dataset library 108) from which data should be queried as well as indications of various data manufacture requirements provided in the user input set. In some embodiments and as further discussed herein, the manufactured dataset generation system 102 may store manufactured datasets (e.g., as they are generated for various users) in the manufactured dataset library 108. In some embodiments, the manufactured datasets stored in the manufactured dataset library 108 may be stored in association with respective sets of data manufacture requirements that were utilized to generate the respective manufactured datasets and, in some embodiments, in association with one or more queries (such as a dataset library query and one or more extended dataset queries (further discussed below)) that were executed to retrieve data from which to generate the respective manufactured dataset. In this regard, the stored associations (e.g., indications of the queries and/or the data manufacture requirements) may be compared with the dataset library query (and/or the data manufacture requirements contained within) to identify manufactured datasets that are likely to contain manufactured data needed for a desired manufactured dataset.

If one or more manufactured datasets of the manufactured dataset library 108 are identified as containing or likely to contain manufactured data that can be leveraged to generate the desired manufactured dataset, the manufactured dataset(s), or portions of manufactured data from the manufactured dataset(s) may then be retrieved. In this regard, as shown by operation 604, the apparatus 200 includes means, such as processor 202, memory 204, communications hardware 206, or the like, for retrieving at least a portion of the identified one or more manufactured datasets.

The retrieved manufactured data may then be analyzed to determine whether the retrieved manufactured data contains enough data needed to generate the desired manufactured dataset or if additional data is needed to generate the desired manufactured dataset. As shown by decision point 606, the apparatus 200 includes means, such as processor 202, memory 204, query generation circuitry 232, or the like, for determining whether the identified one or more manufactured datasets satisfy a requirement threshold. The requirement threshold may be based on the full scope of data manufacture requirements set forth by the user input set. In this regard, if certain data is needed to satisfy some data manufacture requirements and that data that is not included in the identified manufactured datasets retrieved from the manufactured dataset library 108, the manufactured dataset generation system 102 may generate one or more additional queries in an attempt to retrieve the data needed from sources other than the manufactured dataset library 108. If the data manufacture requirements are not satisfied, the method may continue to operation 608. In this regard, as shown by operation 608, the apparatus 200 includes means, such as processor 202, memory 204, query generation circuitry 232, or the like, for identifying a portion of the data manufacture requirements having not yet been satisfied by the identified one or more manufactured datasets.

As shown by operation 610, the apparatus 200 includes means, such as processor 202, memory 204, query generation circuitry 232, or the like, for generating an extended dataset query based at least on the identified portion of the data manufacture requirements. In this regard, the extended dataset query may be generated to include the remaining data manufacture requirements that have not yet been satisfied. An extended dataset query may include one or more queries that are configured to execute over locations in memory outside of the manufactured dataset library 108. For example, the locations may comprise one or more remote data sources (e.g., remote data sources 114A-114N). In some embodiments, remote data sources 114A-114N may comprise remote data sources that are internal to an organization that manages the manufactured dataset generation system 102. For example, as noted earlier, the manufactured dataset generation system 102 may be implemented and/or managed by a large organization such as a financial institution which possesses significant volumes of real data (e.g., data collected from customers and/or through various business applications) hosted in multiple repositories managed by the large organization. In some embodiments, remote data sources 114A-114N may comprise remote data sources that are external to an organization that manages the manufactured dataset generation system 102, such as third-party repositories or the like that are managed by a different organization. In some embodiments, the extended dataset query may be generated to execute over both internal remote data sources and external remote data sources external to the organization in order to retrieve the data necessary to satisfy the remaining data manufacture requirements.

In some embodiments, the extended dataset query may be generated based on output of one or more trained models that are configured to predict locations (e.g., certain remote data sources) that are most likely to host the data needed to satisfy the remaining data manufacture requirements. In this regard, the apparatus 200 includes means, such as processor 202, memory 204, modeling circuitry 216, or the like, for determining, using a trained model, a predicted location set indicating one or more data locations from which to retrieve data likely to satisfy the portion of the data manufacture requirements. For example, the model(s) may be trained on historic instances of data retrieval by the manufactured dataset generation system 102 in that the model(s) can accurately predict where certain data (or types of data) can or is likely to be found. In this regard, the extended dataset query can include the specific predicted data locations (e.g., names of databases, etc.) along with the data manufacture requirements such that the manufactured dataset generation system 102 can attempt to retrieve relevant data from the predicted data sources.

As shown by operation 612, the apparatus 200 includes means, such as processor 202, memory 204, query generation circuitry 232, or the like, for causing execution of the extended dataset query. In some embodiments, execution of the extended dataset query may return a second set of results comprising one or more datasets (or portions thereof) retrieved from the one or more remote data sources (e.g., remote data sources 114A-114N). In this regard, the apparatus 200 includes means, such as processor 202, memory 204, communications hardware 206, or the like, for receiving, based on the execution of the extended dataset query, a second set of results. In some embodiments, the second set of results may then be used in combination with the set of results returned by the execution of the dataset library query (e.g., as described above in connection with operations 508 and 510 of FIG. 5) to generate a desired manufactured dataset.

Once the second set of results is obtained (or, alternatively, if the data manufacture requirements were satisfied by the set of results obtained from executing the dataset library query as shown in FIG. 6 in connection with decision point 606), the method may then return to operation 512 of FIG. 5, wherein the apparatus 200 includes means, such as processor 202, memory 204, dataset generation circuitry 212, or the like, for generating a manufactured dataset based at least on the set of results. In this regard, the manufactured dataset generation system 102 may leverage a complete set of results (which may include the sets of results returned by the dataset library query and/or the extended query) to generate a manufactured dataset according to the specific data manufacture requirements outlined by the user input set. For instance, some portion of the datasets included in the set of results may be used as source data or a basis for generating synthetic data to be included as part of the manufactured dataset. As another example, some portion of one or more datasets included in the set of results may be included as-is as part of the manufactured dataset. As yet another example, some portion of one or more datasets included in the set of results may be obfuscated to some degree (e.g., masked, tokenized, etc.) and the obfuscated data may be included as part of the manufactured dataset.

In some embodiments, once generated, the manufactured dataset may be automatically stored in the manufactured dataset library 108. In this regard, as shown by operation 514, the apparatus 200 includes means, such as processor 202, memory 204, query history circuitry 230, or the like, for storing the manufactured dataset in the manufactured dataset library. In some embodiments, the manufactured dataset may be stored in association with the manufactured dataset library query, the extended dataset query, and the data manufacture requirements which were used to generate the manufactured dataset. By storing the manufactured dataset in association with this information, for example, a future manufactured dataset library query that is executed over the manufactured dataset library 108 may readily identify the manufactured dataset as having been generated based on similar data manufacture requirements of a user input set used to generate the future manufactured dataset library query. In this case, the manufactured dataset may then be retrieved and used at least in part to generate another manufactured dataset.

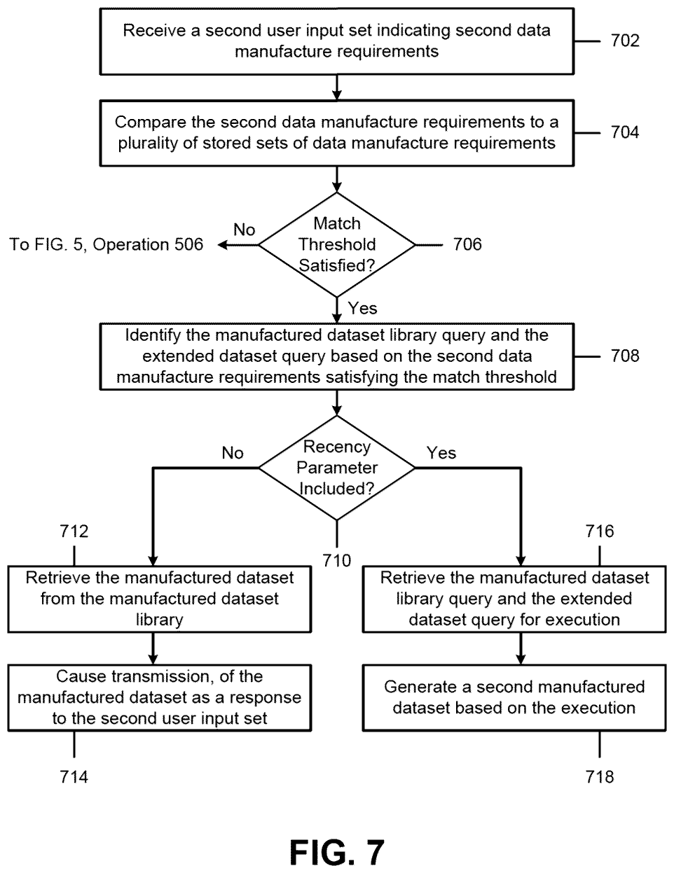

Turning to FIG. 7, example operations are shown for identifying and retrieving existing queries and/or manufactured datasets in the event a matching threshold is satisfied. As shown by operation 702, the apparatus 200 includes means, such as processor 202, memory 204, communications hardware 206, or the like, for receiving a second user input set indicating second data manufacture requirements. For example, another user (e.g., a user different from the user that provided the user input set discussed above in connection with FIG. 5) of the manufactured dataset generation system 102 may utilize the manufactured dataset generation UI to generate a second user input set.

However, many users may have generated user input sets prior to this user, and data manufacture requirements of these user input sets have been stored (e.g., in association with previously generated manufactured datasets stored in the dataset library 108). In this regard, the data manufacture requirements specified by the second user may match or be very similar to data manufacture requirements for which a manufactured dataset (and one or more queries) has already been generated and stored. Said differently, a second user may submit a user input set that matches a user input set having already been submitted. In this case, the manufactured dataset generation system 102 may conserve computational resources by retrieving a previously generated manufactured dataset instead of generation one or more queries and generating a new manufactured dataset (which would be very similar to if not the same as the previously generated manufactured dataset). In this regard, the apparatus 200 includes means, such as processor 202, memory 204, query history circuitry 230, or the like, for comparing the second data manufacture requirements to a plurality of stored sets of data manufacture requirements. The comparison may include determining whether a match threshold is satisfied between the second data manufacture requirements and a stored set of data manufacture requirements. In this regard, as shown by decision point 706, the apparatus 200 includes means, such as processor 202, memory 204, query history circuitry 230, or the like, for determining whether a match threshold is satisfied between the second data manufacture requirements and stored sets of data manufacture requirements based on the comparison. For example, the match threshold may require a 100% match (e.g., all data manufacture requirements in the second user input set must be included in a stored set of data manufacture requirements). In some embodiments, for example, the match threshold may be tuned to a lower percentage (e.g., 90%, 85%, etc.).

If the match threshold is not satisfied between the second data manufacture requirements and any of the stored sets of data manufacture requirements, the method may continue to operation 506 of FIG. 5, wherein a manufactured dataset library query is generated for the second data manufacture requirements. In this regard, as described above, a new query is generated to retrieve some data needed for a portion of the second data manufacture requirements. However, if the match threshold is satisfied between the second data manufacture requirements and a stored set of data manufacture requirements, the method continues to operation 708, wherein the apparatus 200 includes means, such as processor 202, memory 204, query history circuitry 230, or the like, for identifying one or more queries (e.g., a manufactured dataset library query and an extended dataset query) based on the second data manufacture requirements satisfying a match threshold to the data manufacture requirements associated with the manufactured dataset library query and the extended dataset query. Said differently, the stored set of data manufacture requirements that is determined to satisfy a match threshold to the second data manufacture requirements may be stored in association with a dataset library query (and optionally one or more extended dataset queries) which was used to generate a manufactured dataset that satisfied the data manufacture requirements of the stored set of data manufacture requirements, and these queries may be readily identified by the manufactured dataset generation system 102 in order to potentially execute them again, if needed. In this regard, if a recency parameter is included in the second data manufacture requirements, the queries may be executed to obtain fresh data points for the desired manufactured dataset. If a recency parameter is not included (i.e., the user is not particular about needing fresh or recently updated data), the manufactured dataset generation system 102 may instead simply retrieve the stored manufactured dataset associated with the stored set of data manufacture requirements, thus save computational resources by avoiding re-execution of any queries. In this regard, the apparatus 200 includes means, such as processor 202, memory 204, query history circuitry 230, or the like, for determining whether a recency parameter is included in a set of data manufacture requirements.

As noted above, if no recency parameter is included in the second data manufacture requirements, the method may continue to operation 712, wherein the apparatus 200 includes means, such as processor 202, memory 204, communications hardware 206, or the like, for retrieving the manufactured dataset from the manufactured dataset library. As shown by operation 714, the apparatus 200 includes means, such as processor 202, memory 204, communications hardware 206, or the like, for causing transmission, by the communications hardware, of the manufactured dataset as a response to the second user input set.

However, if a recency parameter is included in the second data manufacture requirements, the method may instead continue to operation 716, wherein the apparatus 200 includes means, such as processor 202, memory 204, communications hardware 206, or the like, for retrieving one or more queries (e.g., the manufactured dataset library query and the extended dataset query) for execution to generate a second manufactured dataset. As shown by operation 718, the apparatus 200 includes means, such as processor 202, memory 204, communications hardware 206, or the like, for causing transmission, by the communications hardware, of the manufactured dataset as a response to the second user input set. Through the comparison of data manufacture requirements of a submitted user input set with previously stored data manufacture requirements as described above in connection with FIG. 7, several technical benefits are realized. For instance, computational resources may be conserved in instances in which a user input set matches or is similar to a previously submitted user input set, allowing for a previously generated manufactured dataset to simply be retrieved and provided to a user (rather than generating and executing one or more queries over potentially multiple remote data sources and subsequently generating a new manufactured dataset). Additionally, performing such comparisons ensures that the manufactured dataset library 108 would not include duplicative datasets, allowing for storage resources to be conserved as well as user experience to be improved when searching or browsing the manufactured dataset library (i.e., a user will not have to sift through multiple extremely similar datasets).

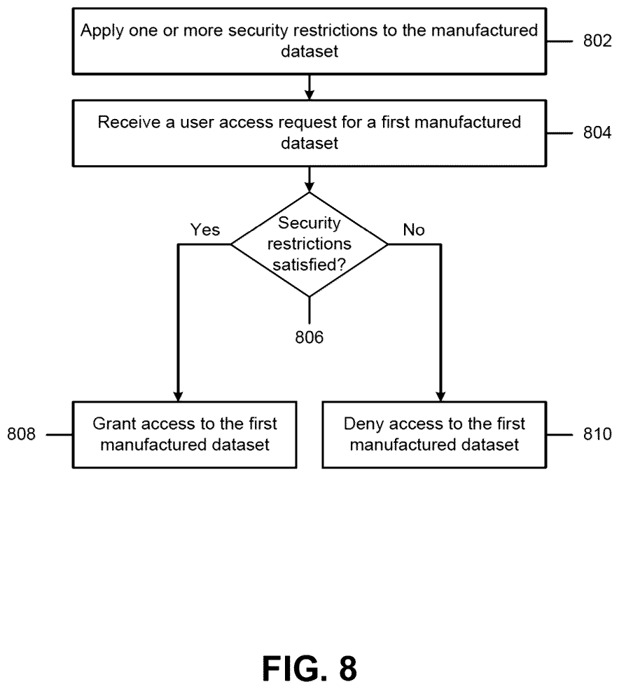

Turning to FIG. 8, example operations are shown for applying and utilizing one or more security restrictions within a manufactured dataset library. As noted above, various security restrictions that may be implemented and applied to one or more manufactured datasets stored in the manufactured dataset library 108. These security restrictions may include, for example, proximity restrictions, time restrictions, and/or user type restrictions. In this regard, as shown by operation 802, the apparatus 200 includes means, such as processor 202, memory 204, security circuitry 218, or the like, for applying one or more security restrictions to a manufactured dataset.

A proximity restriction may comprise a geofence or other location-based security restriction. For example, a user attempting to access a manufactured dataset having a proximity restriction may only be able to do so if the device they are using to perform the access attempt is located within a predefined location range. As one example, a manufactured dataset may only be accessible within a range of an office building (thus requiring the employee attempting to access the manufactured dataset to be present within the building). In some embodiments, the manufactured dataset generation system 102 may acquire location data from a client device attempting to access a manufactured dataset having a proximity restriction (e.g., via location-enabled services). Location data may include Global Positioning System (GPS) coordinates, latitude/longitude points, and/or other types of location information used to identify a location at which the client device is located. If the location data indicates that the client device is out of range of the geofence, the manufactured dataset generation system 102 may deny access to the manufactured dataset. If the location data indicates that the client device is in range or within the geofence, the manufactured dataset generation system 102 may grant access to the manufactured dataset (or, in some embodiments, prior to granting access, verify that one or more other security restrictions applied to the manufactured dataset are also satisfied).

In some embodiments, certain manufactured datasets may be restricted to a specific application and location. In this manner, a user may not export or otherwise remove a manufactured dataset from a designated zone. For example, training of a model using a manufactured dataset may only be permitted to be performed within a high security environment in order to minimize exposure of any sensitive data related to the manufactured dataset. The high security environment may include one or more computing devices which can temporarily store the model and/or the manufactured dataset. The high security environment may include a physical zone only accessible to select trusted personnel. The high security environment may include various data protection mechanisms, such as firewalls and/or the like which protect and encapsulate data within the high security environment. In some embodiments, the manufactured dataset generation system 102 itself may reside in the high security environment.

A time restriction may comprise a time-based security restriction in which a manufactured dataset is only accessible during certain times (e.g., during certain hours, such as between 9 AM and 5 PM). In some embodiments, a time restriction may be based on a sensitivity of the manufactured dataset. For example, a time restriction may set a predefined date and/or time at which the manufactured dataset will be removed from the manufactured dataset library 108. In this regard, due to a high sensitivity of the data, the manufactured dataset may only be available for a set period of time to avoid overexposure of the data. As another example, a time restriction may comprise a predefined number of accesses of the manufactured dataset. For example, as various users continue to access (e.g., view, retrieve, etc.) the manufactured dataset from the manufactured dataset library 108, the manufactured dataset generation system 102 may keep track of the number of accesses (e.g., in a transaction log described above and further herein) and, when a predefined number of accesses is reached, the manufactured dataset may be locked (e.g., no longer able to be accessed) or removed from the dataset library. This may be due to the sensitivity of the manufactured dataset and/or other factors, such as storage space or the like.

A user type restriction may comprise a security restriction which limits access to a manufactured dataset to only certain types of users. For example, knowledgeable users (or “power” users) familiar with the manufactured dataset generation system may be allowed access to more manufactured datasets than newer or less experienced users. As another example, users employed by an organization which manages the manufactured dataset generation system 102 may have access to certain manufacture datasets which other users (e.g., non-employees) may not have access to.

As shown by operation 804, the apparatus 200 includes means, such as processor 202, memory 204, communications hardware 206, or the like, for receiving a user access request for a first manufactured dataset. The user access request may be received (e.g., from a client device) in response to a user selecting the manufactured dataset (e.g., in the manufactured dataset library 108) in an attempt to view or retrieve the first manufactured dataset. The user access request may include a transmission of data to the manufactured dataset generation system 102 which includes various data needed to determine whether security restrictions associated with the first manufactured dataset are satisfied or not. For example, a user access request may include location data (e.g., to identify where the client device is located for one or more proximity restrictions) and/or a user type indication that indicates a status, position, role, or other type for the user (e.g., to identify where the user type indication satisfies a user type required by a user type restriction).

As shown by decision point 806, the apparatus 200 includes means, such as processor 202, memory 204, security circuitry 218, or the like, for determining whether one or more security restrictions associated with the first manufactured dataset are satisfied. For example, the manufactured dataset generation system 102 can verify that all security restrictions (e.g., proximity restrictions, user type restrictions, time restrictions, etc.) applied to the first manufactured dataset are satisfied before granting the user access to the first manufactured dataset.

If all security restrictions are determined to be satisfied, the method may continue to operation 808, wherein the apparatus 200 includes means, such as processor 202, memory 204, security circuitry 218, or the like, for granting access to the first manufactured dataset. If any security restrictions are determined not to be satisfied, the method may continue to operation 810, wherein the apparatus 200 includes means, such as processor 202, memory 204, security circuitry 218, or the like, for denying access to the first manufactured dataset.

In some embodiments, the manufactured dataset generation system 102 may create and store transaction logs for manufactured datasets stored in the manufactured dataset library 108. A transaction log may be stored in association with a manufactured dataset and may be automatically updated in response to events associated with the manufactured dataset. In this regard, the apparatus 200 includes means, such as processor 202, memory 204, recordation circuitry 220, or the like, for generating a transaction log for a manufactured dataset. In some embodiments, a transaction log may comprise manufactured dataset indicators associated with generation and usage of a manufactured dataset. The manufactured dataset indicators may be data constructs which include various data (e.g., metadata) regarding events associated with a manufactured dataset. In some embodiments, manufactured dataset indicators may comprise one or more of timestamp data, access data, and property data.

Timestamp data may include data indicating dates and times of various events associated with a manufactured dataset. For example, timestamp data may include a timestamp indicating a date and time of the generation of the manufactured dataset and/or a timestamp indicating a date and time at which the manufactured dataset was first stored in the manufactured dataset library. Timestamp data may include a timestamp indicating a date and time at which the manufactured dataset was last accessed. Timestamp data may include a timestamp indicating a date and time at which the manufactured dataset was last updated or modified.

Access data may include data indicating various users (e.g., by user identifiers, employee identifiers, and/or other identifiers) that accessed and/or retrieved the manufactured dataset or are otherwise associated with the manufactured dataset (e.g., user(s) that submitted a user input set from which the manufactured dataset was generated). Access data may include data linking various users to companies or other organizations the users are associated with, historical data of the users including various project types and/or other manufactured datasets associated with the users, and/or the like.

Property data may include data indicating various properties of the manufactured dataset. For example, property data may include data indicating one or more security restrictions that are applied to the manufactured dataset. Property data may include a sensitivity level of the manufactured dataset (e.g., high sensitivity, low sensitivity). Property data may indicate a refresh rate associated with the manufactured dataset. A refresh rate may indicate a specific period (e.g., every 30 days) which the manufactured dataset is automatically updated (e.g., with newer “fresher” data).

As noted above, the manufactured dataset generation system 102 may be configured to periodically ensure that certain manufactured datasets stored in the manufactured dataset library 108 reflect most current data points available. In this regard, data (e.g., data stored in one or more remote data sources and/or the manufactured dataset library) used to build a manufactured dataset can periodically be queried automatically (or in response to a user request) for updated or new data, and, if updated or new data is found, and the manufactured dataset can be automatically updated to include or reflect the updated or new data. In some embodiments, a manufactured dataset can be replaced with an updated manufactured dataset in the manufactured dataset library, or alternatively, a new version of the manufactured dataset can be stored, and users may be enabled to access both versions depending on their needs. In this regard, the apparatus 200 includes means, such as processor 202, memory 204, dataset generation circuitry 212, or the like, for automatically updating a manufactured dataset based on new or updated data associated with at least one of (i) the manufactured dataset library and (ii) one or more remote data sources.

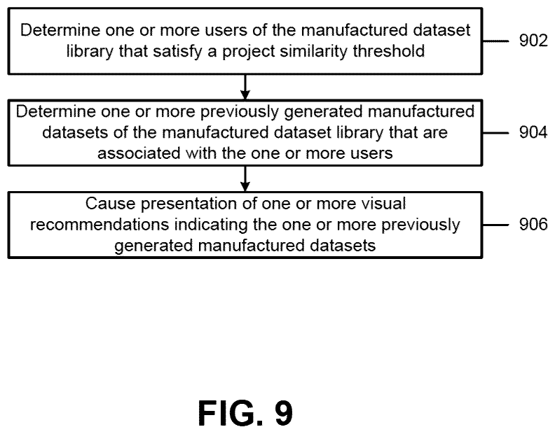

In some embodiments, in connection with maintaining transaction logs described above, the manufactured dataset generation system 102 may track various user activity. For example, in some embodiments, a first user's activity (e.g., interactions with the manufactured dataset generation system 102) may be tracked to record specific manufactured datasets the first user selects for use (e.g., accesses and/or retrieves) and/or inputs they provide to the system (e.g., data manufacture requirements defined in a user input set). This information may be leveraged by the manufactured dataset generation system 102 to identify users similar to the first user (e.g., users who access and/or retrieve similar manufactured datasets or having similar data manufacture requirements). When similar users are identified, the manufactured dataset generation system 102 may output (e.g., display) various recommendations, such as manufactured datasets accessed by and/or generated for those similar users, to the first user. In this regard, turning to FIG. 9, example operations are shown for recommending previously generated manufactured datasets based on a project similarity threshold.

As shown by operation 902, the apparatus 200 includes means, such as processor 202, memory 204, user intelligence circuitry 222, or the like, for determining, based at least on the data manufacture requirements, one or more users of the manufactured dataset library that satisfy a project similarity threshold. In this regard, the manufactured dataset generation system 102 may infer a project similarity between two or more users based on data manufacture requirements either submitted by the users or associated with manufactured datasets accessed by the users. For example, if two users submit similar user input sets, it may be inferred that the users are working on similar projects (e.g., modeling projects which have a similar goal).

As shown by operation 904, the apparatus 200 includes means, such as processor 202, memory 204, user intelligence circuitry 222, or the like, for determining one or more previously generated manufactured datasets of the manufactured dataset library that are associated with the one or more users. For instance, for two users inferred to have project similarity, the manufactured dataset generation system 102 may identify one or more manufactured datasets accessed by or generated for a first user and subsequently provide a notification (e.g., via the manufactured dataset generation UI) to the second user recommending the identified one or more manufactured datasets. In this regard, as shown by operation 906, the apparatus 200 includes means, such as processor 202, memory 204, communications hardware 206, or the like, for causing presentation of one or more visual recommendations indicating the one or more previously generated manufactured datasets.

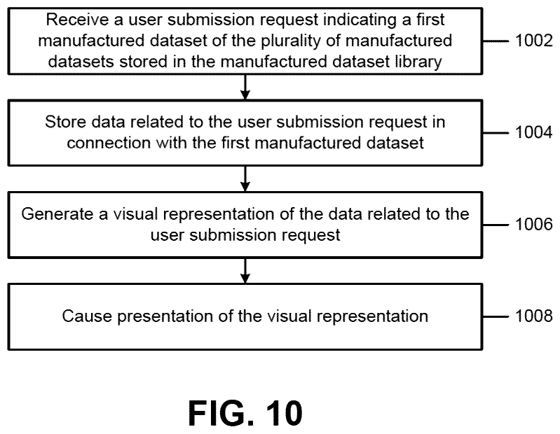

As noted above, in some embodiments, social engagement between users via the manufactured dataset generation system 102 may be enabled through various feedback mechanisms. For example, users may be enabled to submit feedback in the form of ratings and/or user comments (e.g., reviews, technical issues, and/or other details) regarding manufactured datasets stored in the manufactured dataset library 108. This feedback may be viewable by other users, who are enabled to submit their own feedback (e.g., replies to comments of other users). Turning to FIG. 10, example operations are shown for providing a feedback loop mechanism within a manufactured dataset library.

As shown by operation 1002, the apparatus 200 includes means, such as processor 202, memory 204, communications hardware 206, or the like, for receiving a user submission request indicating a first manufactured dataset of the plurality of manufactured datasets stored in the manufactured dataset library. The user submission request may comprise a data construct that includes data (e.g., text data) such as a comment or rating of a particular manufactured dataset stored in the manufactured dataset library 108. Once received, the user submission request may optionally be preprocessed to determine whether the comment is actually relevant to the manufactured dataset (e.g., is not spam, offensive, or otherwise irrelevant). As shown by operation 1004, the apparatus 200 includes means, such as processor 202, memory 204, query history circuitry 230, or the like, for data related to the user submission request in connection with the first manufactured dataset. In this regard, the feedback provided in the user submission request may be stored in connection with the manufactured dataset such that the feedback can be visually presented in conjunction with the manufactured dataset. As shown by operation 1006, the apparatus 200 includes means, such as processor 202, memory 204, interface generation circuitry 208, or the like, for generating a visual representation of the data related to the user submission request. For example, the feedback (e.g., comment, rating, etc.) may be visually represented in the form of a comments thread, message box, or other representation. As shown by operation 1008, the apparatus 200 includes means, such as processor 202, memory 204, communications hardware 206, or the like, for causing presentation of the visual representation. For example, the visual representation may be presented via the manufactured dataset generation UI when a user accesses the manufactured dataset in the manufactured dataset library 108 thus allowing the user to gain additional insights (e.g., various user perspectives) into a manufactured dataset before deciding to utilize the manufactured dataset for a particular application.

As described above, example embodiments provide methods and apparatuses that enable improved generation and management of manufactured datasets. By implementing a user-friendly interactive graphical user interface that provides a multitude of options for defining and refining requirements for a manufactured dataset, example embodiments thus mitigate negative and/or otherwise complex issues that often arise in conventional processes for generating manufactured datasets. Through utilization of the above-described technical operations in connection with the interactive manufactured dataset generation UI, new and practical tools are unlocked that allow teams to collaborate on generating manufactured datasets via a UI while also allowing less advanced users to more easily articulate their needs for a manufactured dataset through the various tools of the UI.

Further, example embodiments provide an additional level of data protection by applying multiple security restrictions to manufactured datasets stored in a manufactured dataset library. Accordingly, example embodiments thus provide another technical improvement in that they enhance the performance of a computing platform implementing synthetic data generation while still mitigating the risk of exposure of any sensitive data. Additionally, as described herein, the manufactured dataset generation system implements numerous methods which conserve computational resources and storage space. As these examples all illustrate, example embodiments contemplated herein provide technical solutions that solve real-world technical problems faced during traditional implementations of manufactured dataset generation and management.

FIGS. 5-10 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, a user input set indicating data manufacture requirements;
generating, by query generation circuitry, a manufactured dataset library query based on the data manufacture requirements;
receiving, by the communications hardware and based on an execution of the manufactured dataset library query, a set of results comprising one or more manufactured datasets of a manufactured dataset library, the one or more manufactured datasets having been previously generated based on one or more previously received user input sets; and
generating, by dataset generation circuitry, a manufactured dataset based on the set of results.

2. The method of claim 1, wherein the user input set comprises at least one of audio data and text data, and wherein the method further comprises:
identifying, by input analysis circuitry, the data manufacture requirements by analyzing the user input set using one or more Natural Language Processing (NLP) techniques.

3. The method of claim 1, further comprising:
causing presentation, by the communications hardware, of a manufactured dataset generation user interface (UI) comprising a plurality of manufactured dataset generation UI elements,
wherein the user input set is received based on user interactions with the plurality of manufactured dataset generation UI elements.

4. The method of claim 1, wherein the data manufacture requirements include one or both of:
(i) a recency parameter, and
(ii) a resource consumption parameter.

5. The method of claim 1, further comprising:
causing, by the query generation circuitry, execution of the manufactured dataset library query.

6. The method of claim 5, further comprising:
identifying, by dataset analysis circuitry, one or more manufactured datasets of the manufactured dataset library based on the manufactured dataset library query; and
retrieving, by the communications hardware, at least a portion of the identified one or more manufactured datasets,
wherein the set of results comprises the identified one or more manufactured datasets.

7. The method of claim 6, further comprising, in an instance in which the set of results fails to satisfy a requirement threshold:
identifying, by the query generation circuitry, a portion of the data manufacture requirements having not yet been satisfied by the identified one or more manufactured datasets;
generating, by the query generation circuitry, an extended dataset query based at least on the identified portion of the data manufacture requirements; and
causing, by the query generation circuitry, execution of the extended dataset query.

8. The method of claim 7, further comprising:
determining, by modeling circuitry and using a trained model, a predicted location set indicating one or more data locations from which to retrieve data likely to satisfy the portion of the data manufacture requirements,
wherein the extended dataset query is generated based further on the predicted location set.

9. The method of claim 7, further comprising:
receiving, by the communications hardware and based on the execution of the extended dataset query, a second set of results,
wherein the manufactured dataset is generated based further on the second set of results.

10. The method of claim 9, wherein the set of results comprises data retrieved from one or both of:
(i) one or more remote data sources internal to an organization, and
(ii) one or more remote data sources external to the organization.

11. The method of claim 7, further comprising:
storing, in the manufactured dataset library and by query history circuitry, the manufactured dataset in association with the manufactured dataset library query, the extended dataset query, and the data manufacture requirements.

12. The method of claim 11, further comprising:
receiving, by the communications hardware, a second user input set indicating second data manufacture requirements;
comparing, by the query history circuitry, the second data manufacture requirements to a plurality of stored sets of data manufacture requirements; and
identifying, by the query history circuitry, the manufactured dataset library query and the extended dataset query based on the second data manufacture requirements satisfying a match threshold to the data manufacture requirements associated with the manufactured dataset library query and the extended dataset query.

13. The method of claim 12, further comprising, in an instance in which the second data manufacture requirements include a recency parameter:
retrieving, by the communications hardware, the manufactured dataset library query and the extended dataset query for execution to generate a second manufactured dataset.

14. The method of claim 12, further comprising, in an instance in which the second data manufacture requirements do not include a recency parameter:
retrieving, by the communications hardware, the manufactured dataset from the manufactured dataset library; and
causing transmission, by the communications hardware, of the manufactured dataset as a response to the second user input set.

15. The method of claim 11, further comprising:
generating, by recordation circuitry, a transaction log for the manufactured dataset,
wherein the transaction log comprises manufactured dataset indicators associated with the generation and usage of the manufactured dataset.

16. The method of claim 15, wherein the manufactured dataset indicators comprise (i) timestamp data, (ii) access data, and (iii) property data.

17. The method of claim 11, further comprising:
applying, by security circuitry, one or more security restrictions to the manufactured dataset.

18. The method of claim 17, wherein the one or more security restrictions comprise one or more of (i) a proximity restriction, (ii) a user type restriction, and (iii) a time restriction.

19. The method of claim 17, further comprising:
receiving, by the communications hardware, a user access request for a first manufactured dataset of a plurality of manufactured datasets in the manufactured dataset library, wherein the user access request comprises a user type indication associated with a first user;
determining whether a user type restriction associated with the first manufactured dataset is satisfied; and
in an instance in which user type restriction associated with the first manufactured dataset is satisfied:
granting, by security circuitry, access to the first manufactured dataset by the first user; and
in an instance in which user type restriction associated with the first manufactured dataset is satisfied:
denying, by security circuitry, access to the first manufactured dataset by the first user.

20. The method of claim 11, further comprising:
automatically updating, by the dataset generation circuitry, the manufactured dataset based on new or updated data associated with at least one of (i) the manufactured dataset library and (ii) one or more remote data sources.

21. The method of claim 11, further comprising:
determining, by user intelligence circuitry and based at least on the data manufacture requirements, one or more users of the manufactured dataset library that satisfy a project similarity threshold;
determining, by the user intelligence circuitry, one or more previously generated manufactured datasets of the manufactured dataset library that are associated with the one or more users; and
causing presentation, by the communications hardware, of one or more visual recommendations indicating the one or more previously generated manufactured datasets.

22. The method of claim 11, further comprising:
receiving, by communications hardware, a user submission request indicating a first manufactured dataset of a plurality of manufactured datasets stored in the manufactured dataset library; and
storing, by the query history circuitry, data related to the user submission request in connection with the first manufactured dataset.

23. The method of claim 22, wherein the user submission request comprises one or more of (i) text data indicating a user comment regarding the first manufactured dataset and (ii) a selected rating of one or more predefined ratings for the first manufactured dataset.

24. The method of claim 22, further comprising:
generating, by interface generation circuitry, a visual representation of the data related to the user submission request; and
causing, by the communications hardware, presentation of the visual representation.

25. An apparatus comprising:
communications hardware configured to receive a user input set indicating data manufacture requirements;
query generation circuitry configured to generate a manufactured dataset library query based on the data manufacture requirements,
wherein the communications hardware is further configured to receive, based on an execution of the manufactured dataset library query, a set of results comprising one or more manufactured datasets of a manufactured dataset library, the one or more manufactured datasets having been previously generated based on one or more previously received user input sets; and
dataset generation circuitry configured to generate a manufactured dataset based on the set of results.

26. A computer program product comprising at least one non-transitory computer-readable storage medium storing software instructions that, when executed, cause an apparatus to:
receive a user input set indicating data manufacture requirements;
generate a manufactured dataset library query based on the data manufacture requirements;
receive, based on an execution of the manufactured dataset library query, a set of results comprising one or more manufactured datasets of a manufactured dataset library, the one or more manufactured datasets having been previously generated based on one or more previously received user input sets; and
generate a manufactured dataset based on the set of results.
